(19) United States
(12) Patent Application Publication
(10) Pub. No.: US 2004/0071888 A1
(43) Pub. Date: Apr. 15, 2004

(54) Apparatus and method of research for creating and testing thin films

(75) Inventors: Konstantinos Chondroudis, Sunnyvale, CA (US); Keith Cendak, Millbrae, CA (US); Martin Devenney, Mountain View, CA (US); C. Eric Ramberg, San Jose, CA (US); Xuejun (Jason) Wang, Fremont, CA (US); Raymond E. Carhart, Cupertino, CA (US); Scott Jeffrey Weigel, Allentown, PA (US); John Francis Kirner, Orefield, PA (US); Thomas Alan Deis, Vista, CA (US); Earl Danielson, Santa Barbara, CA (US); James Edward MacDougall, New Tripoli, PA (US); Lisa Deis, Pittsburgh, PA (US); Sum Nguyen, Fremont, CA (US)

Correspondence Address: SENNIGER POWERS LEAVITT AND ROEDEL, ONE METROPOLITAN SQUARE, 16TH FLOOR, ST LOUIS, MO, 63102, US

(73) Assignees: Symyx Technologies, Inc.; Air Products and Chemicals, Inc.

(21) Appl. No.: 10/448,788

(22) Filed: May 30, 2003

Related U.S. Application Data
(60) Provisional application No. 60/384,258, filed on May 30, 2002.

(51) Int. Cl. B05D 1/36; B05C 11/00

(52) U.S. Cl. 427/402; 118/663; 118/688

(57) ABSTRACT

The present invention is generally relates to the field of research for the discovery of films with desirable properties, and to a process for making such films. More particularly, the present invention is directed to a system or an apparatus and a method for the rapid formation of a library of liquid samples and a library of thin films therefrom, as well as to the rapid screening of these films to identify those having desirable properties, all of which may be achieved using combinatorial techniques.

### REFERENCE TO RELATED APPLICATION

This application claims priority from U.S. Provisional Application Serial No. 60/384,258 filed on May 30, 2002, the entire contents of which are incorporated herein by reference.

### BACKGROUND OF THE INVENTION

The present invention generally relates to the field of research for the discovery of films with desirable properties, and to a process for making such films. More particularly, the present invention is directed to a system or an apparatus and a method for the rapid formation of liquid samples and thin films therefrom, as well as to the rapid screening of these films to identify those having desirable properties, all of which may be achieved using combinatorial techniques.

The discovery of new materials with novel chemical and/or physical properties often leads to the development of new and useful technologies. Currently, there is a considerable amount of activity in the discovery and optimization of materials, such as superconductors, zeolites, magnetic materials, magneto-resistive materials, phosphors, nonlinear optical materials, thermoelectric material, luminescent materials, catalytic materials, and high and low dielectric materials. Aiding in this process is the relatively recent application of combinatorial chemistry techniques, which previously revolutionized the process of drug discovery, to the research, development and commercialization of materials. (See, e.g., Weinberg et al., U.S. Pat. No. 6,030,917 and Schultz et al., U.S. Pat. No. 6,004,617, both of which are incorporated herein by reference.)

Combinatorial materials science generally refers to the methods for creating a collection or library of chemically diverse compounds or materials, to the methods for rapidly testing or screening this library of compounds or materials for desirable performance characteristics and properties, and to the methods for storing, retrieving and analyzing the data from these experiments. For example, Weinberg et al. and Schultz et al. recognized that combinatorial strategies offer promise for the discovery of various materials and, compared to traditional discovery methods, combinatorial methods can sharply reduce the costs associated with preparing and screening each candidate material.

In the past, it has been disclosed that arrays of materials may be prepared by a variety of techniques, including chemical vapor deposition, physical vapor deposition or liquid dispensing. U.S. Pat. Nos. 6,004,617 (Schultz et al.) and 6,333,196 (Willson), for example, disclose a variety of methods for synthesizing and screening or measuring arrays of materials for useful properties. However, when applying combinatorial techniques to a particular problem, the optimal techniques to apply to array or library design, synthesis, screening or measuring, and/or informatics may not be straightforward. For example, Schultz et al. disclose using spin-coating in combination with photolithography to deposit a reactant component onto a substrate. Also, U.S. Pat. Nos. 6,313,044 and 6,291,628 disclose that it is known in the semiconductor industry to coat the entire surface of a semiconductor wafer using what is commonly referred to as spin-coating technology. Conventional spin-coating techniques involve forming a liquid solution by dissolving a material in a volatile solvent and then depositing the liquid solution on the center of a wafer. The wafer is then rotated by a spin-coating device at a high speed to spread the material across the entire wafer surface and to facilitate evaporation of the solvent, thereby leaving a thin film coating on the wafer surface. The liquid solution is thus spread over the substrate surface without directly touching the solution, such as with a finger, doctor blade, brush or the like so as to minimize the risk of contaminating the solution. However, such conventional techniques are not advantageous for use in synthesizing an array of films, primarily because only a single, relatively large (e.g., 3-6 inch diameter) wafer is coated at a time or additional steps, such as masking schemes, must be used.

Accordingly, a need continues to exist for an efficient method and apparatus or system for the research, discovery and development of thin films that have, for example, desirable physical, electrical, mechanical, thermal and/or optical characteristics. Ideally, such a process would employ combinatorial techniques wherein libraries of compounds or materials are prepared and used to prepare libraries of films, optionally on a common substrate, to be tested for or to measure a particular property of interest.

### SUMMARY OF THE INVENTION

Among the features of the present invention, therefore, is the provision of a method, as well as an apparatus or system, for performing combinatorial synthesis of diverse libraries of materials from which libraries of diverse thin films are formed, the films then being measured or tested for a particular film property of interest; the provision of such an invention wherein a sample may optionally be taken from an initial or parent library of materials to form a secondary or daughter library of diverse materials, from which thin films may alternatively be prepared; the provision of such an invention wherein multiple thin films are formed on a common substrate; the provision of such an invention wherein thin films are formed on different substrates in parallel; the provision of such an invention wherein samples of parent or daughter library members are applied in liquid form to a substrate surface; the provision of such an invention wherein samples are subjected to a spreading force (e.g., noncontact or air knife spreading forces) to form thin films; the provision of such an invention wherein force is applied to the composition or components or materials on the substrate(s) to cause material library samples deposited thereon to spread discretely over the surface thereof; the provision of such an invention wherein the spreading force is caused by, for example, moving the substrate or by applying a stream of pressurized gas thereto.

Further among the various features of the present invention is included a system or collection of apparatuses for preparing such a library of materials and films, and for measuring or testing these films for multiple properties of interest.

Still further among the various features of the present invention is a method, as well as a system or collection of apparatuses for carrying out the method, for generating a database, as well as the database obtained therefrom, wherein multiple arrays or libraries of materials are prepared having various compositions which are used to form thin films which are then measured, tested or screened for a property of current or potential future interest, the database containing collected data sets of data elements associated with film composition and the manner in which the film, and/or the material from which the film was formed, was prepared, as well as the property of the film for which it was measured, tested or screened; the provision of such an invention wherein one data set is correlated to another data set; the provision of such an invention wherein the database is used to identify or determine if a film having a property of interest meets a predefined criterion; the provision of such an invention wherein the database is later used to identify a film having a property different from an initial property of interest; the provision of such an invention wherein the database is used to identify films for scale-up and further testing; the provision of such an invention wherein the database is an electronic database; the provision of such an invention wherein the electronic database is accessible from a remote location (e.g., via internet access); and, the provision of such an invention wherein the database is used to develop new libraries of materials, which differ from those already used for the database by of chemical composition and/or process history, from which the thin films are formed.

Briefly, therefore, the present invention is direct to a system for the research and development of films. The system comprises: an apparatus for receiving and combining starting components to form separate mixtures at known locations in a matrix of wells of a common receptacle; an apparatus that receives the starting component mixtures and subjects said mixtures to conditions sufficient for a reaction to occur, thereby forming a parent library of reaction compounds; an apparatus that receives said parent library and deposits, in liquid form, samples from one or more members of said library on a surface of at least one substrate, and subjects said samples to a spreading force sufficient to spread the samples over the surface of the at least one substrate to form respective films thereon, said apparatus comprising at least one of the following combinations of devices: (i) a deposition device adapted for depositing at least two liquid samples on the surface of the at least one substrate in generally spaced relationship with each other, such that the at least two liquid samples are at least partially discrete from each other, and a movement device capable of supporting the substrate(s) with the liquid sample(s) deposited thereon, said movement device being operable to subject the liquid samples to a noncontact spreading force, during overlapping durations of time, sufficient to cause the samples to spread over the at least one substrate surface to form respective films thereon, at least a portion of each film being discrete from one or more other films; or, (ii) a deposition device adapted for depositing at least two liquid samples on the surface of the at least one substrate in generally spaced relationship with each other, such that the at least two liquid samples are at least partially discrete from each other, a support for supporting the at least one substrate with the liquid sample(s) deposited thereon, and a gas delivery device operable to direct a pressurized gas to impact said liquid samples to apply a spreading force thereto sufficient to cause the liquid samples to spread over the surface of the substrate(s) to form respective films thereon, at least a portion of each film being discrete from one or more other films; and, an apparatus for measuring a property of interest of said film.

The present invention is still further directed to a combinatorial method for the research and development of films which comprises: forming a parent library of members in a spatially addressable format, each member comprising a mixture of starting components; forming multiple films by (i) depositing, in liquid form, at least two samples on a surface of at least one substrate, wherein each sample is deposited on said at lest one substrate in generally spaced relationship with each other, so at to be at least partially discrete, and further wherein each sample comprises a member of the parent library, and (ii) subjecting the samples to a spreading force sufficient to spread the samples over the surface of the at least one substrate to form respective films thereon, wherein said film formation is achieved by one of the following: (a) depositing at least two liquid samples on the at least one substrate surface in generally spaced relationship with each other, such that each of the at least two samples are at least partially discrete from each other, and subjecting said liquid samples to a noncontact spreading force sufficient to cause each sample to spread over the at least one substrate surface to form respective films thereon, at least a portion of each film being discrete from one or more other films; or, (b) depositing at least two liquid samples on the surface of at least one substrate, such that each of the samples are at least partially discrete from each other, and directing a pressurized gas to impact said liquid samples to apply a spreading force thereto sufficient to cause the liquid samples to spread over the at least one substrate surface to form a respective film thereon; and, measuring each film for a property of interest.

The present invention is still further directed to a method for generating a database containing information relating to films. This method comprises: combining starting components to form a series of separate mixtures at known locations in a matrix of wells of a common receptacle; subjecting the starting component mixtures to conditions sufficient for a reaction to occur, thereby forming a parent library of reaction compounds; forming a film of one or more library members by depositing, in liquid form, at least two liquid samples from one or more of such members on a surface of at least one substrate and subjecting the samples to a spreading force sufficient to spread the samples over the surface of the at least one substrate to form a respective film thereof; measuring said films for multiple properties; and, collecting data associated with each film into a database, said data comprising data sets of data elements relating to film composition, including starting component mixture content and conditions for forming the library member from which said film was derived, conditions for forming said film, and the results of measuring said film.

Additional features of the present invention will be in part apparent and in part pointed out hereinafter.

### BRIEF DESCRIPTION OF THE DRAWINGS

FIGS. 1 through 21 provide various views of apparatuses which are suitable for executing various aspects of the present invention (e.g., subjecting samples deposited on a substrate surface to a spreading force to form a film thereon), as well as photographs of films formed on substrates using such apparatuses and the methods described herein. More specifically:

FIG. 1 is a schematic perspective of a first embodiment of an apparatus for forming films on substrates;

FIG. 2 is a photograph of films formed on a substrate using the apparatus of FIG. 1;

FIG. 3 is side elevation of a movement device of a second embodiment of an apparatus shown supporting a substrate;

FIG. 4 is a top plan view of the movement device of FIG. 3 with the substrate omitted;

FIG. 5 is a photograph of films formed on a substrate using the movement device of FIG. 3;

FIG. 6 is a perspective of a movement device of a third embodiment of an apparatus shown supporting a substrate;

FIG. 7 is a side elevation thereof with portions omitted to reveal internal construction and with other portions shown in cross-section;

FIG. 8 is a photograph of films formed on a substrate using the movement device of FIG. 6;

FIG. 9 is a schematic side view of a substrate holder and an air knife of a fourth embodiment of and apparatus for forming a film on a substrate, with the air knife shown in cross-section;

FIG. 10 is a top view of the substrate holder and air knife of FIG. 9; FIG. 11 is a side elevation of a fifth embodiment of an apparatus for forming a film on a substrate;

FIG. 12 is a top plan view thereof of the apparatus of FIG. 11;

FIG. 13 is a perspective of a portion of the apparatus of FIG. 11 showing a drive system and an array of substrate holders of the apparatus;

FIG. 14 is a top plan view of the drive system and substrate holders of FIG. 13;

FIG. 15 is a side elevation of the drive system and substrate holders of FIG. 13;

FIG. 16 is a cross-section taken in the plane of line 16-16 of FIG. 14 with a control system for the drive system shown schematically;

FIG. 17 is a fragmented cross-section of one substrate holder of the apparatus of FIG. 11;

FIG. 18 is a perspective of one substrate holder driven by a corresponding motor;

FIG. 19 is an exploded perspective of the substrate holder and motor of FIG. 18;

FIG. 20 is a cross-section of an array of substrate holders and a second embodiment of a drive system for the substrate holders;

FIG. 21 is a schematic side view of apparatus of a sixth embodiment of an apparatus for forming films on a substrate showing a heater for heating substrates on which films are formed;

FIG. 22 is a block diagram which illustrates how the apparatus and various methods of forming films on substrates may be utilized in the present invention as part of a system or workflow for the rapid formation of liquid samples and thin films therefrom, as well as the rapid screening of these films to identify those having desirable properties, all of which may be achieved using combinatorial techniques; and,

FIG. 23 is a block diagram which illustrates some of the various steps that are, or may optionally be, involved in such a system or workflow.

Corresponding reference characters indicate corresponding parts throughout the drawings.

### DETAILED DESCRIPTION OF THE PREFERRED EMBODIMENTS

Generally speaking, in one embodiment, the present invention is directed to a method and an apparatus or a system for preparing and identifying thin films which have desirable properties, including for example mechanical, electrical, thermal, morphological, optical, magnetic, chemical, etc., as further described herein. More specifically, the present invention is directed to a combinatorial method, as well as an apparatus or a system designed for carrying out such a method, wherein a library of materials or compounds or components (sometimes referred to herein as the parent library), from which samples are taken to form thin films that are subsequently examined for a particular film property of interest, is prepared. Each member of the parent library generally differs in some way from the others, for example due to chemical composition and/or process history; that is, the parent library may have chemical or process diversity, as further described herein.

Since the reactions or process steps of the present invention (e.g., preparation of materials for the parent or daughter libraries, preparation of the thin film product libraries therefrom, etc.) may be carried out or conducted in parallel, the number of reactions or steps can be minimized. Moreover, the reaction conditions at different reaction regions (in the case of the parent and/or daughter libraries) can be controlled independently. As such, processing conditions that may be varied or controlled include, for example, (i) in the case of compound or material preparation, varying amounts (e.g., volume, moles or mass) and ratios of starting components, time for reaction, reaction temperature, reaction pressure, rate of starting component addition to the reaction, timing of starting component addition to the reaction, residence time or the time the components are allowed to remain in contact to react, or alternatively the product removal rate, reaction atmosphere, mixing or stir rate, duration of aging or storage, and (ii) in the case of film deposition or preparation, the conditions under which samples are placed on the substrate surface and spread to form a thin layer (e.g., the amount of material or compound deposited on the substrate surface, the force applied to or the manner by which the sample is spread over the surface, the concentration or viscosity of the sample), the conditions under which the sample is then cured to form a film, etc., as well as other conditions that are well recognized by those of ordinary skill in the art. It is in part through the creation of libraries having such diversity, and screening of those diverse library members for a property of interest (in this case, screening films formed from diverse members for a film property of interest), that a complete combinatorial research and development program can be undertaken for identification of thin films having the particular properties of interest.

It is to be noted that while samples or aliquots of one or more of the members of the parent library may be withdrawn and deposited on the surface of a substrate to formed thin films thereon, optionally these aliquots may be used to form one or more additional libraries, sometimes referred to herein as daughter libraries. For example, each daughter library may be considered to be a replica of the parent library, but each member of the daughter library would be smaller than the corresponding parent member in terms of either volume or moles or mass. Like the parent library, each daughter library may also possess chemical or process diversity. When such daughter libraries are prepared, samples or aliquots of them, as well as or instead of the parent library, maybe withdrawn and deposited on a substrate surface for purposes of forming thin films.

It is to be further noted that while members of the libraries will, in one preferred embodiment, be a liquid or fluid, in alternative embodiments the members may be for example in solid, suspension or dispersion form. In such cases, however, samples which are to be used to prepare thin films for testing are dissolved, dispersed or suspended in a suitable solvent before being further processed in accordance with the present invention.

It is to be still further noted that the present invention optionally provides for different screening stages, such as a primary test or measurement to eliminate some members from a library and prevent them from undergoing further processing or sent on to a secondary test. Alternatively, however, as further described herein, films may be subjected to a series of tests, the series essentially encompassing any test that may be of potential interest, such that a large amount of data can be collected at one time. In either approach, the resulting product library of thin films is tested or measured in some way, the data being collected in a database for further processing and evaluation; that is, the data generated upon testing of a film itself is collected and correlated with other data in the database (including for example the conditions under which the film, or the material from which the film was derived, was formed or prepared, as well as the composition thereof), in order to identify a film having the desired properties. Once potential candidate films are identified (i.e., films having properties falling within parameters previously set), more of the material from which the identified film was formed may be prepared as needed (e.g., 5×, 10×, etc. scale-up), and a larger or scale-up film prepared (e.g., a single film is formed on the surface of a given substrate, rather than multiple films, or alternative a film is formed on the surface of a larger substrate, using for example common spin-coating techniques known in the art). The resulting scale-up film may then be further tested to evaluate its properties against (i) the results from the identified film (i.e., the smaller-scale film), to determine if anything changed as a result of the scale-up, and/or (ii) predetermined parameters, in order to identify a film having the desired properties on the desired scale. As such, several iterations of the present process may in some cases be performed. Furthermore, such results may be used to determine when additional, new parent libraries of diverse compounds or materials are needed for further study (e.g., when no film falls within the predetermined criteria).

The embodiments of the methodology of the present invention may be combined into a flexible system that includes a number of different apparatuses, optionally located at a number of different locations or stations, including for example one or more apparatus or stations for combining and/or reacting starting materials, forming daughter libraries, forming thin films, testing or measuring or screening the resulting films, and collecting data. The system also includes a controller or control system that monitors and directs the activities of the apparatus of the system so that a user may design an entire series of experiments by inputting library design, testing or data manipulation criteria. The system optionally includes an automated data collection and processing system, as well as a filtering apparatus and station.

Accordingly, in one embodiment, this invention is directed to the means whereby materials or compounds are rapidly created and tested to identify thin films having desirable properties, thus offering significant advantages over conventional experimental methods and systems. For example, the present invention allows for the automated parallel creation of materials or compounds, as well as thin films therefrom, and the testing of these films for a property of interest. As such, the multiple synthetic routes for preparing materials and forming thin films may be evaluated, thereby saving time and decreasing the costs associated with determining appropriate films for desired applications or uses. Given that the invention also provides for a variety of measuring or screening options, flexibility is afforded in choosing the appropriate process flow and conditions for a particular application of interest.

In this regard it is to be noted that the present invention accordingly enables the generation and collection of a large amount of data that may be used or screening for various purposes. More specifically, the present invention enables data to be collected by means of, for example, simply testing or measuring a given material's various properties for collection, or conducting a more sophisticated screening process, wherein a given material is measured for a particular property or group of properties of interest, which are then compared to some predetermined criteria or “figure of merit” to determine or evaluate that material's potential use for a given purpose (i.e., the material is measured to determine if it passes or fails as compared to a particular figure of merit).

A. Parent Library

The parent library in the present invention is a library that comprises members possessing chemical and/or process diversity, which are to be formed into thin films that are then to be screened for a property of interest. As used herein, “chemical diversity” generally refers to a library having members that vary in terms of atoms or molecules, while “process diversity” generally refers to a library having members that may have begun with the same atoms or molecules, but which have subsequently been subjected to different processing conditions and are different as a result thereof.

The members of this library may essentially be anything that can be formed into a thin layer on a substrate surface and sufficiently screened or tested or measure for a property of interest, as further described herein. More specifically, as further described herein, in at least some embodiments, the thin films of the present invention are to be formed by means of depositing a sample or aliquot of the material or compound on the surface of a substrate, in liquid form, and then subjecting the sample, either directly (e.g., by subjecting to a stream of air) or indirectly (e.g., by movement of the substrate itself), to some spreading force to cause the sample to disperse or spread over the substrate surface.

Accordingly, the liquid from which each film is formed may be substantially any liquid solution, dispersion or suspension from which a film remains upon evaporation of the solvent. For example, the liquid may be a material from which, upon evaporation, decomposition or otherwise reaction, a film is formed of silicon dioxide, polyimides or other organic polymers (e.g., nonbiological organic polymers), ceramic materials, composite materials (e.g., inorganic composites, organic composites and combinations), photoresists, sol-gel solutions including polymeric metal (organic) oxoalkoxides, other metallo-organic compounds, polymer-based light-emitting materials including plastic, solutions and suspensions of ferroelectric materials, and optical coatings.

Such materials or compounds may be prepared by techniques common in the art, including for example, solution-based synthesis techniques, photochemical techniques, polymerization techniques, template-directed synthesis techniques, epitaxial growth techniques, by the sol-gel process, by thermal, infrared or microwave heating, by calcination, sintering or annealing, by hydrothermal methods, by flux methods, by crystallization through vaporization of solvent, etc. Other useful techniques that can be used to simultaneously react the starting components of interest will be readily apparent to those of skill in the art.

In this regard it is to be noted that, as further described herein, in at least some instances the manner by which the starting materials are combined (i.e., the order in which the starting components are added to each other) may be of particular interest and worthy of combinatorial experimentation and study. More specifically, it is to be noted that experience to-date suggests that the order in which starting components are combined can, in some instances, impact the nature of the resulting reaction product and/or the film prepared therefrom. Given that such results are not easily explained or understood, the use of combinatorial experimental techniques is particularly well-suited to study the impact the order of addition may have in a given situation.

As further described herein, it is also to be noted that the material or compound may be such that it forms a film of a sufficient surface area and uniform thickness, such that it can be accurately screened by the appropriate technique. As such, the material or compound is preferably also capable of forming a sample that will yield such a film. The thickness of the films formed on the substrate surface is generally a function of various properties of the liquid (or other sample form) from which the film is formed, such as the viscosity, the wettability (e.g., how well the liquid coats the substrate surface) and the volatility (e.g., the vapor pressure) of the solution or dispersing medium, and the amount of spreading force to which the liquid samples are subjected, as will be described elsewhere herein. Generally speaking, in at least some instances, the more viscous the liquid sample, the thicker the resulting film will be for a given spreading force. Alternatively, for a more viscous liquid, the spreading forces (e.g., stress magnitudes, strain rates, frequencies, amplitudes and the like) can be varied to obtain a desired film thickness. As an example, the viscosity of the liquid sample, in at least some embodiments, may typically be in the range of about 1×10⁻⁴ to about 1×10⁴ Pa-sec., and may preferably be in the range of about 5×10⁻⁴ to about 1×10³ Pa-sec., more preferably in the range of about 1×10⁻³ to about 1×10² Pa-sec., and still more preferably in the range of about 1×10⁻² to about 1×10¹ Pa-sec.

1. Low Dielectric Materials

In one embodiment, materials or compounds which are designed to form low dielectric films, such as those described in co-pending U.S. applications entitled “Low Dielectric Materials and Methods for Making Same,” both filed on May 30, 2002 (Attorney Docket Nos. 06281 USA and 06294Z USA), and European Pat. Application No. EP 1 142 832 Al, all of which are incorporated in their entireties herein by reference, may be used. More specifically, in one embodiment the present invention utilizes directed to low dielectric materials, in order to form thin films therefrom. In the case of the materials disclosed in these two “Low Dielectric Materials and Method for Making Same” applications, two measured attributes of a low dielectric material, dielectric constant and elastic modulus, are correlated into one figure of merit, the normalized wall elastic modulus (E₀′), that can be used to identify and develop improved low dielectric materials (i.e., materials having low dielectric constants yet high enough elastic modulus to tolerate subsequent processing steps, such as etching and CMP processes). In this connection, materials with substantially identical normalized wall elastic modulus values belong to a family of materials whose dielectric constant and elastic modulus can be adjusted by varying the porosity; that is, by determining the normalized wall elastic modulus of a dielectric material, it may be possible to “tune” the dielectric constant and elastic modulus of the film of the invention by varying the pore size and distribution of the pores in the film. Thus, once an improved dielectric material is identified (i.e., one with a higher normalized wall elastic modulus), the target dielectric constant can be obtained by varying the porosity. Moreover, in at least one embodiment, these dielectric materials may have a relatively low metal content and allow for ease of manufacture in comparison to other materials in the art.

In this regard it is to be noted that, as used herein, the term “normalized wall elastic modulus” refers to the wall elastic modulus of a material that is normalized to a wall with a dielectric constant of 4.2, which is the dielectric constant of a SiO₂ dense oxide material. Once the dielectric constant (K) and the elastic modulus (E) of a material are measured, the normalized wall elastic modulus (E₀′) can be calculated. The E₀′ of the material is calculated using Maxwell's relationship for mixed dielectrics applied to porous materials, the measured value for dielectric constant (K), a wall K_{SiO2} of 4.2, Day's 2-d circular hole model for elastic modulus extended to 3-d cylindrical pores with the modulus measured perpendicular to the pore axes, and the measured value for E. While the derivation for the normalized wall elastic modulus is based upon cylindrical pores in the extension of the Day model and spherical inclusions in the Maxwell model, it is anticipated that other types and forms or porosity, i.e., noncylindrical, open porosity, closed porosity, etc., would fall within the scope of this combinatorial method, as it relates to low dielectric materials.

In one embodiment, such low dielectric materials may have a dielectric constant of about 3.7 or less, about 2.7 or less, or even less than about 1.95. Such materials may also have a normalized wall elastic modulus (E₀′), derived in part from the dielectric constant of the material, of about 15 GPa or greater, about 20 GPa or greater, or even greater than about 26 GPa. Further, in some embodiments, these materials may have alkali impurity levels less than about 500 ppm. In these or other embodiments, the materials may have a dielectric constant of about 2.0 or less, a normalized wall elastic modulus that ranges from between about 5 GPa to about 15 GPa, and have a metal impurity level of less than about 500 ppm (e.g., less than about 250 ppm, 1 ppm, 500 ppb, 100 ppb, 10 ppb). In some particular embodiments, the material may have (i) a dielectric constant of about 4 or less, a normalized wall elastic modulus (E₀′) of about 15 GPa or greater, and a metal impurity level of about 500 ppm or less; (ii) a dielectric constant of less than about 1.95 and a normalized wall elastic modulus (E₀′) of greater than about 26 GPa; or, (iii) a dielectric constant of less than about 2.0, a normalized wall elastic modulus (E₀′) that ranges from between about 5 GPa to about 15 GPa, and a metal impurity level of about 500 ppm or less. In addition, in one or more of such embodiments, the film may optionally be porous, may optionally not exhibit a diffraction peak, and/or may optionally comprise silica-carbon bonds, all as further described herein.

These low dielectric materials may comprise silica. The term “silica,” as used herein, is a material that has silicon (Si) and oxygen (O) atoms, and possibly additional substituents such as, but not limited to: other elements such as H, C, B, P, or halide atoms; alkyl groups; or aryl groups. In certain preferred embodiments, the material may further comprise silicon-carbon bonds having a total number of Si-C bonds to the total number of Si atoms ranging from between about 20 to about 80, or from between about 40 to about 60, mole percent.

2. Parent Library Formation

The parent library may be created by combinatorial chemistry methods generally known in the art (see, for purposes of illustration, methods for preparing libraries described in co-pending U.S. patent application Ser. No. 08/327,513 entitled “The Combinatorial Synthesis of Novel Materials,” published as WO 96/11878, which is herein incorporated by reference), wherein for example reagents or starting components are added to an array or matrix of wells of a common receptacle or substrate. It is to be noted, however, that the method of preparing or synthesizing the members of the parent library is not narrowly critical to the present invention. Alternatively, there may be bulk manufacturing and bulk storage of the parent compounds, such that one or more of the parent library members is made in a greater quantity than needed and stored for future use or testing under different conditions. In any case, once prepared, the parent library members may optionally be stored for a period of time in order to “age” or “cure” them accordingly.

It is also to be noted that, as further described herein, one or more of the parent libraries may be stored and retrieved from a storage rack for transfer for further use, such as to a daughtering apparatus or a diluting apparatus or a dissolution apparatus or a film-forming apparatus, as further discussed below. Such retrieval and transfer to another apparatus, to station wherein the apparatus is located, may be automated using known automation techniques, such as those disclosed in WO 98/40159, incorporated herein by reference. Robotic apparatus is commercially available, for example from Cavro, Tecan, Robbins, Labman, Bohdan or Packard, which are companies that those of skill in the art will recognize.

It is to be further noted that, in some embodiments, the parent library may additionally include standards, blanks, controls or other members that are present for other reasons. In addition, the parent library may have two or more members which are identical as a redundancy option, or when reaction conditions or film-forming conditions (rather than material or compound composition) are to be combinatorialized. Furthermore, in some embodiments the members of the parent library may be in the form of a solid, suspension, dispersion or solution for storage purposes; however, when in the form of a solid, dispersion or suspension, the members are typically dissolved in a suitable solvent before being used to form thin films.

The parent library or array may consist of, for example, about 10, 100, 10³, 10⁴, 10⁵, 10⁶ or more different compounds or materials. In some embodiments, the density of the regions wherein each compound or material is contained may be greater than about 0.04 regions/cm², preferably greater than about 0.1 regions/cm², more preferably greater than about 1 region/cm², still more preferably greater than about 10 regions/cm², and still more preferably greater than about 100 regions/cm². In some particularly preferred embodiments, the density of regions per unit area may be greater than about 1,000 regions/cm², about 10,000 regions/cm², about 100,000 regions/cm², about 1,000,000 regions/cm², or even about 10,000,000 regions/cm².

B. Thin Film Preparation

Another type of library of the present invention is the product or thin film library. Once the parent compound or material library has been prepared, the product library is formed by removing a sample or an aliquot of one or more members of the parent library (or daughter library) and depositing that sample on a substrate surface, or multiple substrate surfaces, to form a library or an array of thin films (i.e., a library or array of thin film may result from the formation of multiple thin films on a single substrate at one time, and/or the formation of one or more films on multiple substrates at one time). The product library, therefore, obtains its diversity either by chemical diversity of the starting components (e.g., the composition of the materials from which the thin films are formed), or by process diversity introduced during preparation of the composition or materials and/or the thin films, or both. The thin film library of the present invention may consist of, for example, at least about 5, 10, 20, 30, 40, 50, 60, 80, 100 or more (e.g., about 10³, about 10⁴, about 10⁵, about 10⁶ or more) different films (i.e., films having process and/or chemical diversity), formed for example by (i) depositing one or more samples on multiple substrates (e.g., at least about 5, 10, 20, 30, 40, 50, 60, 80,100 or more, as previously noted), and/or (ii) depositing multiple samples (e.g., at least about 5,10, 20, 30, 40, 50, 60, 80, 100 or more, as previously noted) on one or more substrates.

Generally speaking, essentially any thin film-forming technique known in the art may be employed in the present invention. More specifically, the materials of the present invention may be applied to the substrate surface and formed into thin films using a variety of different methods known in the art including, for example, dipping, rolling, or brushing. The coated substrate may then be heated to complete the hydrolysis of the silica source (if necessary), continue the gelation process, and drive off any remaining solvent, if present, from the film. In other embodiments, such as plasma enhanced chemical vapor deposition (“PECVD”), high density PECVD, photon assisted CVD, plasma-photon assisted (“PPECVD”), CVD of a liquid, or transport polymerization (“TP”) (see, e.g., U. S. Pat. Nos. 6,171,945 and 6,054,206 for some exemplary CVD methods that may be used with the present invention), the compound or material may be heated to temperatures sufficient to vaporize and form particulate that coat the substrate.

Other processes that can be used to form the film include spin on deposition methods. In some preferred embodiments of the present invention, non-contact induced spreading forces may be used to apply the mixture, such as the techniques and apparatus described in co-pending U.S. patent application Ser. No. 10/158,375 entitled “Apparatus and Method for Forming Films on Substrates,” filed on May 30, 2002 (which is incorporated herein by reference in its entirety), and as further described herein. Other, related processes that may be used to apply the mixture include oscillating non-contact induced spreading forces. Advantageously, such methods allow films to be formed without the need of contact masks or shutters, in order to control where on the substrate surface a “library” or “array” member is located, or to control what regions on the substrate surface receive a component or material.

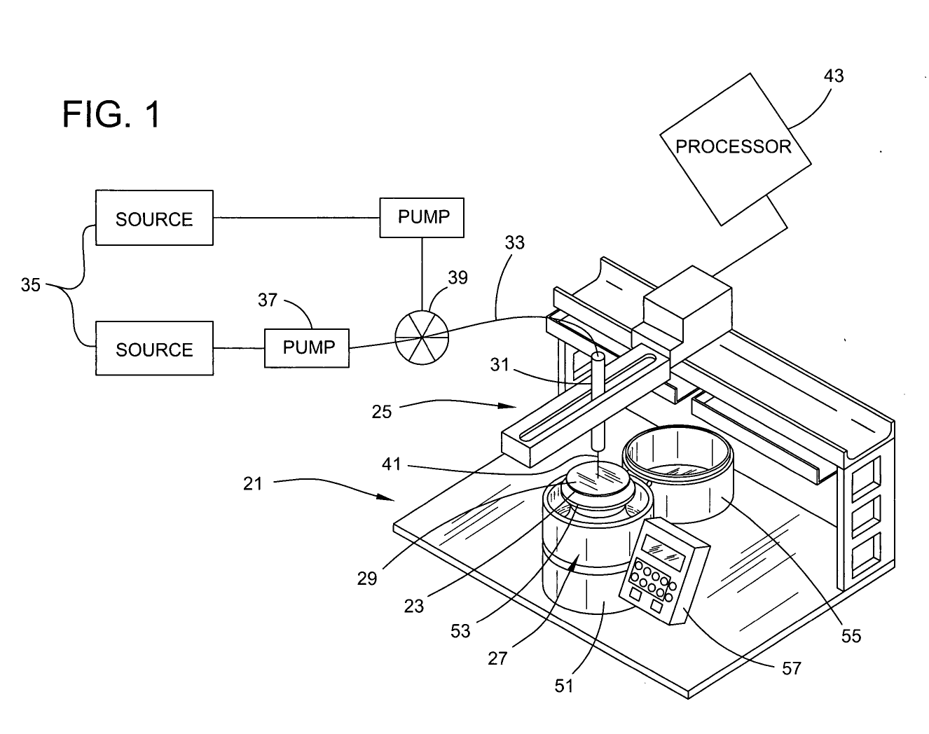

As described in “Apparatus and Method for Forming Films on Substrates,” and with reference to FIG. 1, a first embodiment of such an apparatus for forming films on substrates is indicated in its entirety by the reference numeral 21. The apparatus 21 is more particularly for forming an array of such films on the surface of a single substrate 23, and even more particularly for the parallel formation of an array of such films on the substrate. The apparatus 21 comprises a deposition device, generally indicated at 25, for depositing one or more liquid samples on the surface of the substrate 23. A movement device, generally indicated at 27, supports the substrate 23 and is capable of moving the substrate to subject the liquid samples to a spreading force, and more particularly to a non-contact spreading force, so as to spread the liquid samples on the substrate and thereby form relatively thin films on the substrate. As used herein, a non-contact spreading force is defined as a force acting on the liquid samples on the substrate 23 by means other than directly contacting the liquid samples with an implement (e.g., other than the substrate itself), such as a doctor blade or other spreading implement, or with a jetted media.

The substrate 23 may be constructed of substantially any material which allows for the formation of films thereon and the subsequent screening of various properties and characteristics of such films. For example, the substrate 23 may be organic, inorganic, biological, nonbiological, or a combination of any of these, and may have any convenient shape, such as a disc, square, sphere, circle, etc. The substrate 23 may be constructed of polymers, plastics, pyrex, quartz, resins, silicon, silica or silica-based materials, carbon, metals, inorganic glasses, inorganic crystals, membranes or other suitable materials which will be readily apparent to those of skill in the art. The substrate 23 has a surface 29 on which the films are to be formed and which may be composed of the same materials as the substrate or, alternatively, the substrate may be coated with a different material to define the exposed substrate surface. Moreover, the substrate surface 29 may be modified without departing from the scope of the invention. For example, for film formation on a hydrophilic silicon substrate using a hydrophobic liquid, the surface can be rendered hydrophobic, if desired, by treating it with Hexamethyldisilazane (HMDS). For other applications, the ambient atmosphere could be modified to further affect the liquid solution/substrate interface (e.g., wetting angle).

The substrate 23 of the illustrated embodiment is a conventional semiconductor wafer having a surface 29 processed to a mirror-like finish to facilitate uniformity of thickness of the films formed thereon. However, it is understood that the substrate surface 29 may have a variety of alternative surface characteristics, depending on the film properties and characteristics to be measured, without departing from the scope of this invention. For example, the substrate surface 29 may have raised or depressed regions on which the synthesis of diverse materials takes place. The wafer shown in FIG. 1 has a diameter of approximately five inches. However, the size of the substrate 23 may be substantially larger or smaller, such as down to about 0.5 inches, depending on the size and number of films to be formed on the substrate.

Still referring to FIG. 1, the deposition device 25 is a robotic device in which a pipette, or probe 31 of the device is manipulated over the substrate surface 29 using a 3-axis translation system. The probe 31 is connected by flexible tubing 33 to one or more sources of liquid from which the films are to be formed. One or more pumps 37 are located along the flexible tubing 33 to draw liquid from the liquid sources and to deliver the liquid to the probe 31. Suitable pumps 37 include peristaltic pumps and syringe pumps. A multi-port valve 39 is disposed in the flexible tubing 33 downstream of the pump(s) 37 to control which liquid is drawn from the liquid sources and delivered to the probe 31 for dispensing onto the substrate 23. The probe 31 includes a tip 41 which broadly defines an outlet of the probe through which small, metered samples of liquid are dispensed onto the substrate surface 29. The tip 41 is preferably spaced above the substrate surface 29 about 0.1 cm to about 6 cm during deposition of liquid onto the substrate 23. While the deposition device 25 of FIG. 1 is illustrated as having a single probe 31 and tip 41, it is understood that the device may have multiple probes 31 and/or multiple tips 41 for delivering multiple liquid samples onto the substrate surface 29 without departing from the scope of this invention. For example, multiple probes 31 each having a corresponding tip 41 may be arranged in a single row or in an array, and may deliver liquid samples onto the substrate surface 29 either serially or concurrently.

The robotic deposition device 25 of the illustrated embodiment is controlled by a processor 43 in which the operator inputs various operating parameters to the device using a software interface. Typical operating parameters include the substrate surface 29 coordinates at which each liquid sample is to be deposited thereon and the liquid sources from which liquid is delivered to the probe for deposition onto the substrate surface. General construction and operation of robotic deposition devices similar to the deposition device 25 of the illustrated embodiment is known in the art and will not be further described herein except to the extent necessary to describe the present invention.

It is also understood that other suitable deposition devices may be used to deposit small, metered liquid samples onto the substrate surface 29 without departing from the scope of the present invention. For example, the deposition device 25 may include a plurality of probes for delivering multiple liquid samples to multiple locations on the substrate surface 29 either sequentially or concurrently. Also, the substrate surface 29 may be moved relative to the probe 31 instead of, or in addition to, the probe being moved relative to the substrate 23. Moreover, the deposition device 25 may be operated manually, instead of robotically, without departing from the scope of the present invention.

The probe tip 41 dispenses liquid therefrom generally in the form of droplets, or samples of liquid. The volume of each liquid sample deposited onto the substrate surface 29 generally depends on the amount of liquid needed to obtain a desired film size. For example, based on limitations inherent in existing film screening techniques and devices, each film is desirably sized to have a surface area of at least about 0.1 mm², preferably in the range of about 0.1 mm² to about 700 mm², and more preferably in the range of about 1 mm² to about 50 mm². The volume of each liquid sample deposited on the substrate surface 29 is preferably in the range of about 0.1 microliters to 10 milliliters, more preferably in the range of about 0.5 microliters to about 500 microliters, still more preferably in the range of about 0.5 microliters to about 100 microliters, even more preferably in the range of about 0.5 microliters to about 50 microliters and most preferably in the range of about 1 microliter to about 10 microliters.

As noted previously, the thickness of the films formed on the substrate surface is generally a function of various properties of the liquid from which the film is formed, such as the viscosity, the wettability (e.g., how well the liquid coats the substrate surface), the volatility (e.g., vapor pressure or boiling point) of the solution or dispersing medium, and the amount of spreading force applied to the liquid samples by the movement device 27. For example, the more viscous the sample, the thicker the resulting film will be for a given spreading force. However, for a more viscous sample, the spreading forces (e.g., stress magnitude, strain rate, frequency, amplitude and the like) can be varied to obtain a desired film thickness. In addition, for some materials, it may be desirable or even necessary to lower the viscosity of the material by dissolving or dispersing the material in a solvent to facilitate the formation of a thinner film. Such a solvent preferably has a boiling point in the range of about −100° C. to about 1,000° C., more preferably in the range of about −50° C. to about 500° C., and most preferably in the range of about 25° C. to about 200° C. However, the more volatile the solvent, the faster it will evaporate after the liquid is deposited onto the substrate surface 29. Consequently, as the volatility of the solvent increases, the spreading force used to form the desired film size before the liquid stops spreading over the substrate surface 29 also increases. Examples of suitable solvents for some embodiments include polar, non-polar and ionic solvents, such as various alkanes, heterocyclic compounds, chlorinated compounds, water and combinations thereof.

The thickness of each film formed on the substrate surface 29 is preferably in the range of about 50 Å to about 100 micrometers, and more preferably in the range of about 1,000 Å to about 10,000 Å. In one preferred embodiment, a portion of the surface area of each film formed on the substrate 23 has a substantially uniform thickness to facilitate more accurate screening of the film. For example, a portion of each film preferably has a thickness which is uniform to within a variation of about 0% to about 20%, more preferably to within a variation of about 0% to about 10%, still more preferably to within a variation of about 0% to about 5% and most preferably to within a variation of about 0% to about 3%. The size (e.g., surface area) of a region within each film formed on the substrate surface 29 is preferably at least about equal to the minimum size used by the measurement method to characterize the film, and is more preferably up to about three times larger than the minimum size used by the measurement method.

With further reference to FIG. 1, the movement device 27 of the illustrated embodiment is a non-oscillatory, or non-reciprocating device, and is more particularly a spin-coating device capable of uni-directional rotation on a rotation axis thereof to subject the liquid sample to subject the liquid samples on the substrate surface 29 to a generally monotonic non-contact spreading force. The spin-coating device 27 comprises a cylindrical housing 51, a motor (not shown) enclosed within a lower portion of the housing, a drive shaft (not shown) rotatably driven by the motor and defining the rotation axis of the device, and a chuck 53 mounted coaxially on the drive shaft for conjoint rotation therewith on the rotation axis of the device. General construction and operation of spin-coating devices similar to that of the illustrated embodiment is known in the art and will not be further described herein except to the extent necessary to describe the present invention.

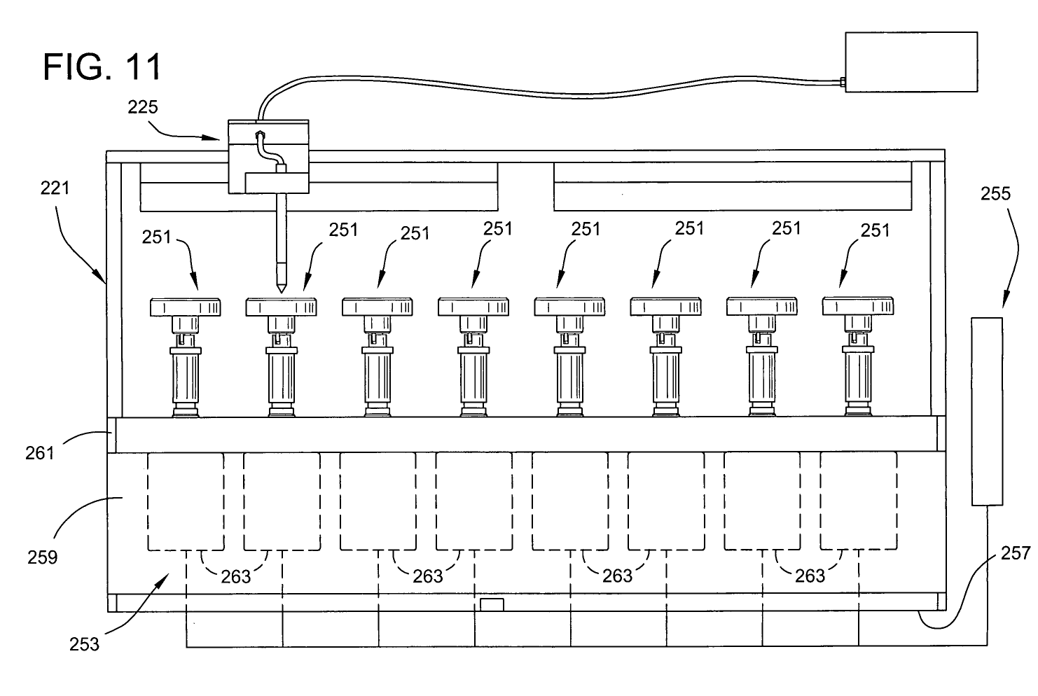

For example, one preferred spin-coating device 27 is available from Laurell Technologies Corporation of Pennsylvania under the model designation WS-400A-6NPP. The cylindrical housing 51 has an internal diameter of about 8.5 inches and a height of about 12 inches. A closure 55 is hinged to the housing 51 to permit closing of the housing during operation of the device 27. The chuck 53 of the illustrated embodiment is a vacuum chuck in fluid communication with a vacuum source (not shown) for suctioning the substrate 23 down against the chuck during operation of the spin-coating device 27. However, it is understood that the substrate 23 may be supported on the drive shaft by means other than a vacuum chuck, such as by mechanical retainers (not shown) or other suitable means without departing from the scope of this invention. The spin-coating device 27 shown in FIG. 1 can support a substrate 23 having a diameter of about three to about six inches or more, and is capable of uni-directional rotation at speeds of up to at least about 6000 rpm. It is contemplated that where a smaller substrate is used, the spin-coating device 27 may be substantially smaller than that shown in FIG. 1. For example, one of the spin-coating devices shown in FIG. 11 and described later herein may be used to rotate a smaller substrate, such as a substrate having a diameter (or width) of about 0.5 inches.

Still referring to FIG. 1, a control system 57 is in electrical communication with the spin-coating device 27 for controlling operation thereof. The control system 57 is preferably a computer based system capable of sending data to and receiving data from the spin-coating device 27 to monitor and control operation of the device. Such data preferably include a motor start time, rotational acceleration and speed, duration of motor operation and other relevant parameters. The control system 57 is also desirably programmable to permit a pre-determined parameter profile, such as a rate of acceleration, duration of operation, rotational speed and stop time to be pre-programmed. For example, the control system 57 may be programmed such that following deposition of one or more liquid samples on the substrate 23, the substrate is subjected to rotation for an initial time period, such as about 5 to 10 seconds, at a relatively low rotational speed, such as about 500 rpm, to promote spreading of the liquid samples on the substrate surface 29. The substrate 23 may then be accelerated to a higher rotational speed, such as about 2000 rpm for a longer duration, such as about 40 seconds, to promote further evaporation of the liquid. It is believed that the hardware and software components of the control system 57 will be readily apparent to those of ordinary skill in this field and therefore will not be described in more detail.

After solvent evaporation has been achieved, the coated substrate may optionally be heated or cured to form the film; that is, heating or cooling of the substrate, ambient or liquid, including changes in heating/cooling rates, can be utilized to affect the film formation. For example, in the case of a dielectric film, a heater, as further described herein, may be used to heat or anneal the film and substrate to a temperature of about 400° C., to promote decomposition of any organic material remaining in the film.

Specific temperature and duration of this heating or annealing step will vary depending upon, for example, the ingredients within the mixture (i.e., the composition of the material and any other additives present), the substrate, and the desired pore structure. The temperature range for this cure step will typically be selected to ensure, for example, that excess water or other volatile matter is evaporated out of the film. In certain preferred embodiments of the present invention, the coated substrate is heated to one or more temperatures ranging from about greater than about 25° C. to less than about 500° C., preferably from greater than about 50° C. to less than about 450° C., and more preferably from greater than about 100° C. to less than about 400° C. The heating or cure step is typically conducted for a time of about 30 minutes or less, preferably about 15 minutes or less, and more preferably about 6 minutes or less. However, in one preferred embodiment, samples were annealed at about 90° C. for about 1.5 minutes, at about 180° C. for about 1.5 minutes, and at about 400° C. for about 3 minutes.

In this regard, it is to be noted, however that the temperature and duration of the heating step employed to aid in film formation may be other than herein described without departed from the scope of the intended invention.

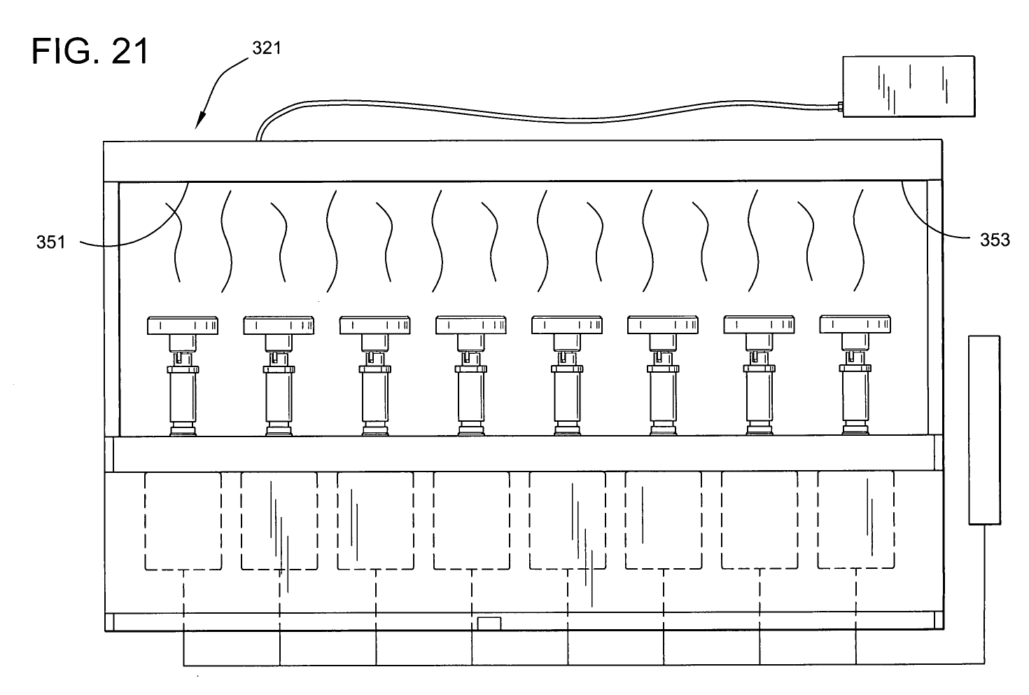

The cure step may be conducted via a hot plate, oven, furnace or the like under controlled conditions such as atmospheric pressure, nitrogen or inert gas atmosphere, under vacuum, or under reduced pressure having controlled oxygen concentration. In preferred embodiments, the heating or curing step may be conducted in a nitrogen or inert gas atmosphere, under vacuum, or under reduced pressure having an oxygen concentration of 100 ppm or lower. In other embodiments, the cure step may be conducted by electron-beam, ozone, plasma, X-ray, ultraviolet radiation or other means. As an example, a heater (not shown in FIG. 1 but similar to a heater 353 shown in FIG. 21 and described later herein), may be positioned above the substrate 23 in opposed relationship with the substrate surface 29, such as at a distance of about 1 mm up to about 100 mm, to heat the substrate, ambient environment and/or liquid samples deposited on the substrate 23 during operation of the spin-coating device 27. The heater is preferably capable of generating heat at a temperature in the range of about 25° C. to about 500° C., more preferably in the range of about 50° C. to about 450° C., and most preferably in the range of about 100° C. to about 400° C. As an example, one preferred such heater is a flat panel infrared heater available from Ogden of Arlington Heights, Ill. under the model designation FP2017 and is operable to generate heat at a temperature of up to about 200° C. Alternatively, it is understood that a cooling device (not shown) may be used to cool the substrate, ambient environment and/or liquid samples without departing from the scope of this invention.

In operation according to a method of the present invention for forming films on a substrate surface 29, and more particularly for forming thin films from liquid samples on the surface of a single substrate, a substrate 23 is secured to the chuck 53 of the spin-coating device 27 generally coaxially with the rotation axis of the device and with the mirror-finish surface of the substrate exposed (e.g., facing up as shown in FIG. 1). The deposition device 25 is then operated to deposit one or more liquid samples on the exposed substrate surface 29. The samples may be deposited serially, such as by the device 25 shown in FIG. 1, or simultaneously, such as by a deposition device (not shown) having multiple probes. It is contemplated that if only one liquid sample is deposited on the substrate surface 29, it may be located offset from the center of the substrate 23 (e.g., relative to the rotation axis of the spin-coating device). In the event more than one liquid sample is deposited on the substrate 23, the liquid samples are preferably deposited thereon in spaced relationship with each other, with the samples all being generally offset from the center of the substrate or with one of the samples being deposited at the center of the substrate.

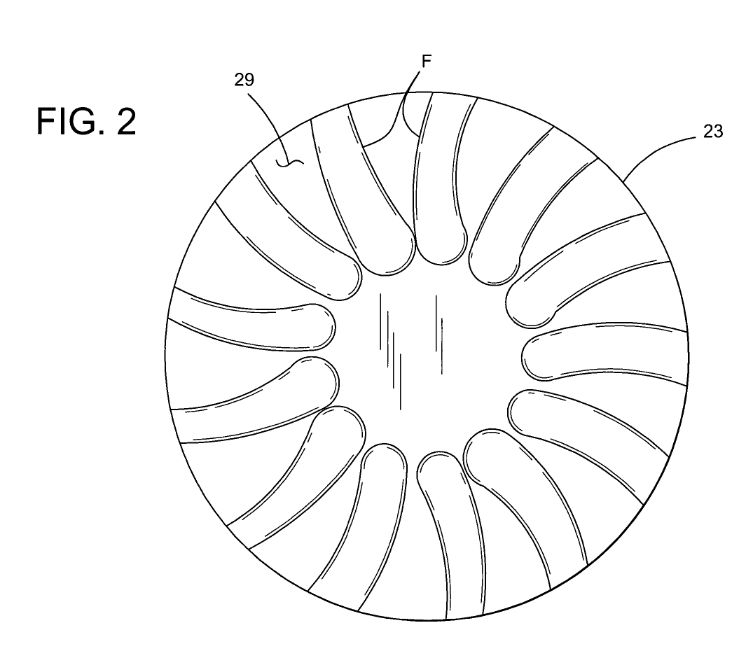

The spin-coating device 27 is then operated to rotate the substrate 23 on the rotation axis of the device. The rotation of the substrate 23 subjects the liquid samples on the substrate surface 29 to a non-contact spreading force, resulting in a shear stress at the liquid sample/substrate surface interface When sufficiently large, this shear stress causes the liquid to spread or flatten on the substrate surface 29 to facilitate thinning of the liquid and evaporation thereof to thereby form corresponding thin films on the substrate surface. For example, unidirectional rotation of the substrate 23 by the spin-coating device 27 of FIG. 1 subjects the liquid samples to a generally monotonic spreading force sufficient to spread or flatten the samples generally tangentially and/or radially outward on the substrate surface 29 as illustrated by the films formed on the substrate shown in FIG. 2.

The liquid samples may be deposited on the substrate surface 29 with sufficient spacing there between such that the corresponding films formed on the substrate surface remain discrete from each other. However, it is understood that portions of adjacent films may overlap each other and remain within the scope of this invention, as long as a portion of each film remains sufficiently discrete from other films on the substrate surface to permit the desired screening of each different film. For example, an area of at least about 0.1 mm² of each film formed on the substrate 23 is preferably discrete from other films formed thereon. It is also understood that certain experimental designs may require overlap between films, e.g., to investigate multilayer phenomena. It is also contemplated that the liquid samples may alternatively be deposited onto the substrate surface 29 during operation of the spin-coating device 27 so that the substrate surface is already rotating as liquid samples are deposited thereon.

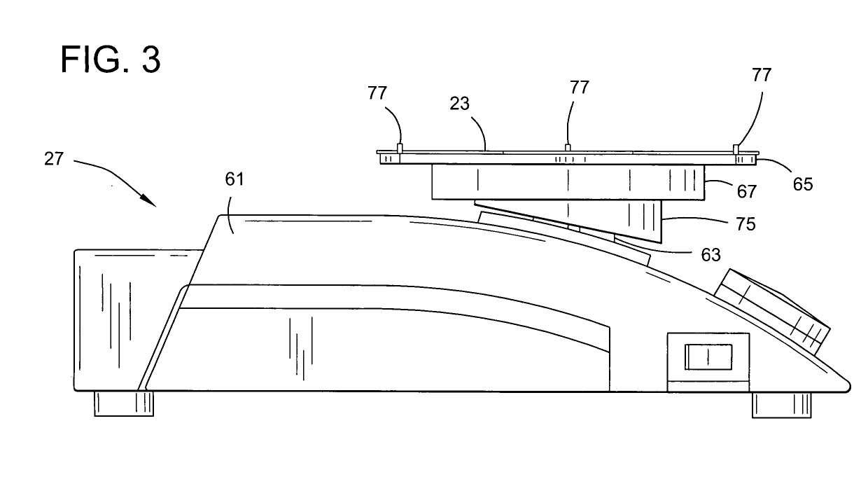

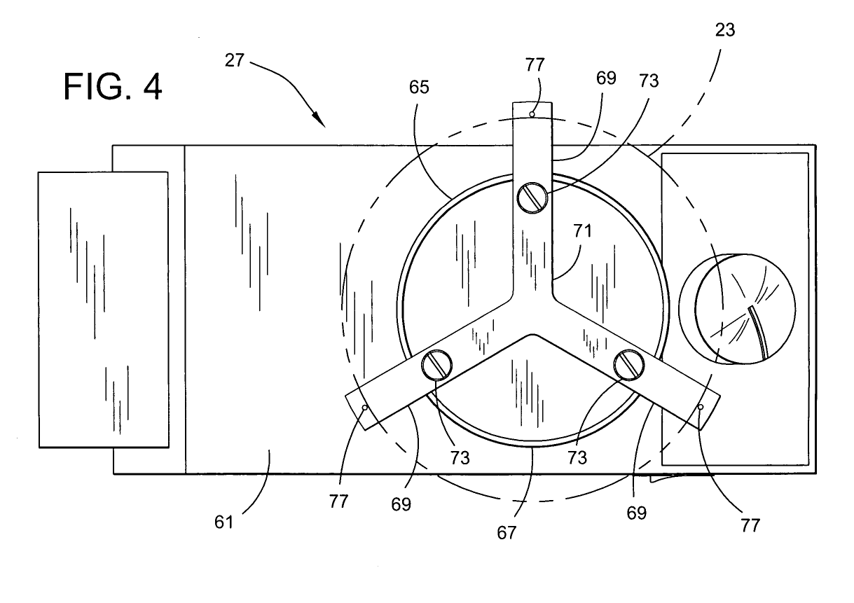

A movement device of a second embodiment of an apparatus 21 suitable for use in the present invention is shown in FIGS. 3 and 4. In this embodiment, the movement device 27 is an oscillatory movement device, and more particularly an orbital movement device capable of oscillating the substrate 27 along an orbital path. The orbital movement device 27 comprises a housing 61 and an orbital drive system (not shown) operatively connected to an orbiting member (FIG. 3) for driving eccentric orbital movement of the orbiting member. The orbiting member 27 of the illustrated embodiment extends up out of the housing 61 and has a substrate holder 65 mounted thereon for conjoint orbital movement with the orbiting member. General construction and operation of orbital movement devices is known in the art and will not be further described herein except to the extent necessary to describe the present invention.

As an example, one preferred orbital movement device 27 is available from IKA-Works, Inc. of Wilmington, N.C., U.S.A., under the model designation MS1 MINISHAKER. The device 27 is capable of driving orbital movement of the substrate holder 65 (and hence the substrate 23 supported by the holder 65) at a speed in the range of about 200 rpm to about 2500 rpm along an eccentric path of up to about 0.177 inches on a major axis and up to about 0.089 inches on a minor axis. In the particular embodiment shown, the holder 65 comprises a base 67 adapted for connection with the orbiting member 19, and three arms 69 (FIG. 4), or spokes extending radially outward from a central hub 71 and secured to the base by suitable fasteners 73. The base 67 of the holder 67 includes a skirt 75 formed integrally therewith and depending therefrom. The skirt 75 is tapered in accordance with the contour of the housing 61 to generally surround and shield the portion of the orbiting member 63 which extends outward of the housing. As seen best in FIG. 4, the arms 69 of the holder 67 are preferably in equiangular relationship with respect to one another (e.g., at angles of about 120° relative to each other). A retainer in the form of a pin 73, for example, extends up from the upper surface of each arm 69 generally adjacent its outer end. The substrate 23 thus seats on the upper surfaces of the arms 69 with the peripheral edge of the substrate 23 generally centered within the pins 73 such that the pins inhibit lateral (e.g., sliding) movement of the substrate on the holder during operation of the orbital movement device 23.

It is contemplated that the apparatus 21 of this second embodiment may also have a control system (not shown but similar to the control system 57 shown in FIG. 1) for controlling the drive system of the orbital movement device 27. For example, the control system 57 may be used to monitor and control the drive system start time, the orbital path and speed of the device, the duration of operation of the drive system and other relevant parameters. It also contemplated that a heater (not shown but similar to the heater 353 shown in FIG. 21 and described later herein) or a cooling device (not shown) may be used to heat or cool the substrate 23 and/or liquid samples during operation of the orbital movement device 27.

In operation, the substrate 23 is placed in the holder 65 of the orbital movement device 27 as described above, with the mirror-finish surface 29 exposed (e.g., facing up in the device of FIG. 3). The deposition device 25 is then operated to deposit one or more liquid samples on the exposed substrate surface 29. The liquid samples may be deposited onto the substrate surface 29 serially, such as by the device shown in FIG. 1, or simultaneously, such as by a deposition device (not shown) having multiple probes. It is contemplated that if only one liquid sample is deposited on the substrate surface 29, it may be located offset from the center of the substrate 23. In the event more than one liquid sample is deposited on the substrate 23, the liquid samples are preferably deposited thereon in spaced relationship with each other, with the samples all being generally offset from the center of the substrate or with one of the samples being deposited at the center of the substrate.

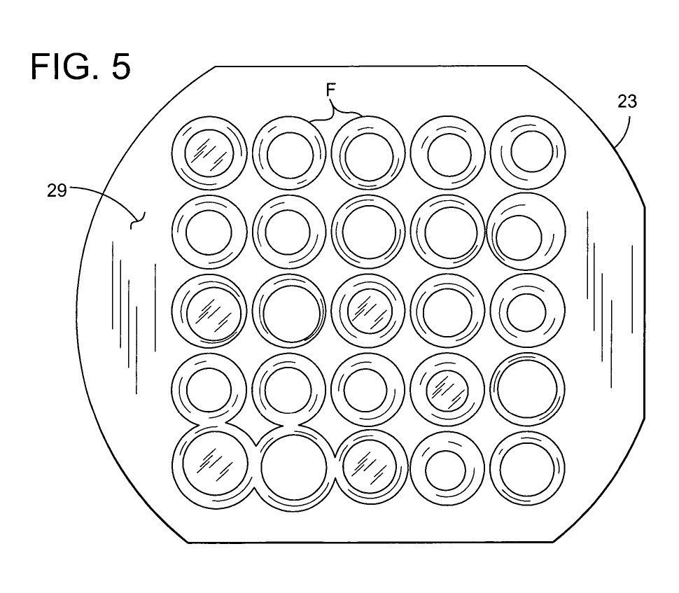

The orbital movement device 27 is then operated to drive movement of the substrate 23 along an orbital path. Orbital movement of the substrate 23 subjects the liquid samples on the substrate surface 29 to a non-contact spreading force, resulting in a shear stress at the liquid sample/substrate surface interface. When sufficiently large, this shear stress causes the liquid samples to spread or flatten on the substrate surface 29 to facilitate thinning of the liquid and evaporation thereof to thereby form corresponding thin films on the substrate surface. For example, orbital movement of the substrate 23 by the orbital movement device 27 of the illustrated embodiment causes each liquid sample to spread or flatten on the substrate surface 29 in a generally circular pattern to form generally circular films F on the substrate in FIG. 5.

The liquid samples are preferably deposited on the substrate surface 29 with sufficient spacing there between such that the films F formed on the substrate surface remain discrete from each other. However, it is understood that portions of adjacent films may overlap each other and remain within the scope of this invention, as long as a portion of each film remains sufficiently discrete from other films on the substrate surface 29 to permit the desired screening of each different film. For example, an area of at least about 0.1 mm² of each film formed is preferably discrete from other films formed on the substrate 23. It also contemplated that the liquid samples may alternatively be deposited onto the substrate surface 29 during operation of the orbital movement device 27 so that the substrate surface is already moving as liquid samples are deposited thereon.

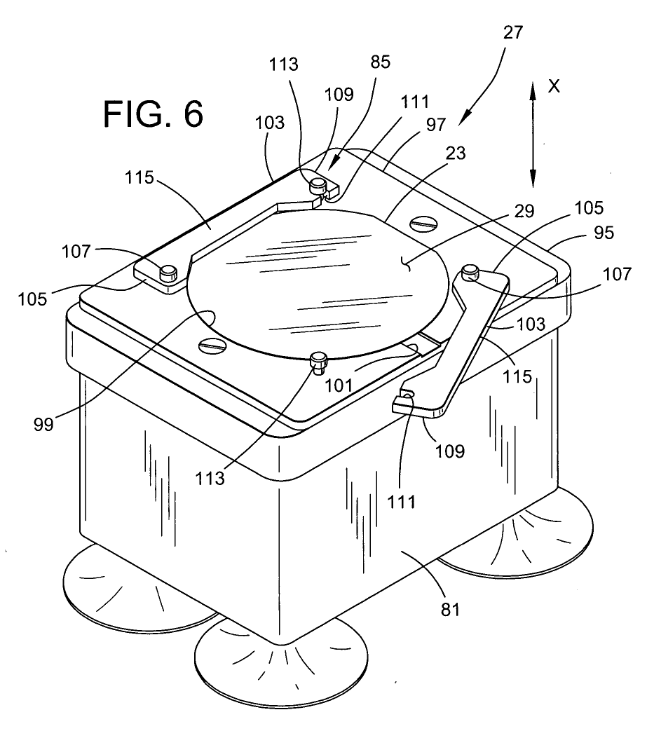

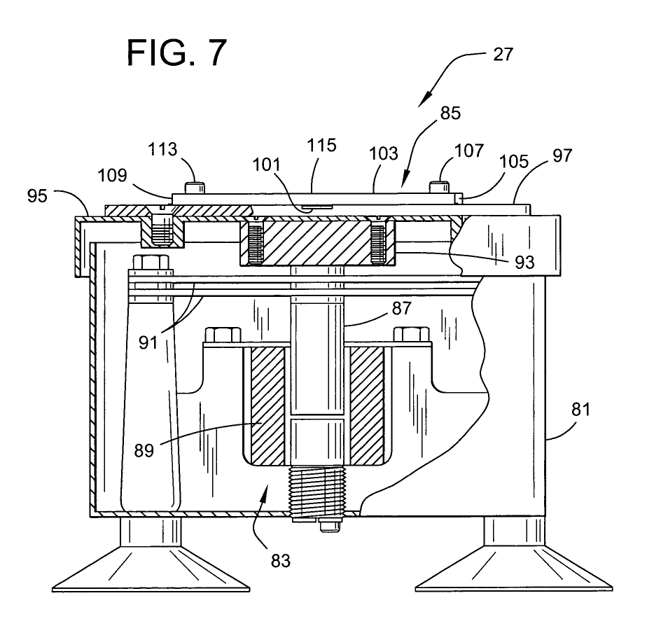

FIGS. 6 and 7 illustrate a movement device 27 of a third embodiment of an apparatus 21 suitable for use in the present invention, in which the movement device subjects the substrate to oscillatory movement. In this embodiment, the movement device 27 is a reciprocating device and, more particularly, a linear reciprocating device capable of reciprocating the substrate 23 along a longitudinal path extending generally normal to the surface 29 of the substrate (e.g., up/down as indicated by the direction arrow in FIG. 6). The linear reciprocating device 27 generally comprises a housing 81, a drive system generally indicated at 83 in FIG. 7, and a holder, generally indicated at 85, operatively secured to the drive system for supporting the substrate 23 during operation of the device. The drive system 83 of the illustrated embodiment is an electromagnetic drive system including an armature 87 coaxially received within a central passage of an electromagnetic coil 89. The armature 87 is movable axially (e.g., vertically) relative to the coil 89 on along a longitudinal path defined by the armature. Leaf springs 91 are secured to the armature 87 toward its upper end for controlling the axial displacement of the armature. The drive system 83 also includes a generally rectangular mounting block 93 secured to the top of the armature 87 for conjoint linear reciprocation therewith. A cover plate 95 is secured to the top of the mounting block 93 for conjoint movement therewith and generally defines the top of the housing 81.

General construction and operation of linear reciprocation devices such as the device 27 described herein and illustrated in FIG. 7 as having an electromagnetic drive system 83 is known in the art and will not be further described herein except to the extent necessary to describe the present invention. For example, U.S. Pat. Nos. 3,155,853 and 4,356,911, the entire disclosures of which are incorporated herein by reference, disclose reciprocating devices having electromagnetic drive systems. One particularly preferred linear reciprocation device 27 is available from Union Scientific Corporation of Randallstown, Md., U.S.A., as a vertical electromagnetic shaker. The drive system 83 is capable of linear reciprocation at a frequency of up to about 60 Hz and an amplitude of up to about 0.15 inches.

As best seen in FIG. 6, the holder 85 comprises a support platform which, in this embodiment, comprises a plate 97 secured to the cover plate 95 and having a depression, or seat 99, formed in its upper surface for receiving the substrate 23 therein. Preferably, the seat 99 has a size and shape closely conforming to the size and shape of the substrate 23 to provide a close clearance fit of the substrate 23 in the seat. A groove 101 is formed within the upper surface of the support plate 97 and extends from the seat 99 out to the peripheral edge of the support plate to facilitate handling of the substrate 23, such as lifting the substrate out of the seat. A pair of retaining arms 103 is secured to the upper surface of the support plate 97 in spaced relationship with each other adjacent the peripheral edge of the seat 99. Each retaining arm 103 is pivotally secured at a pivot end 105 thereof to the upper surface of the support plate 97 by a suitable fastener 107. An opposite, free end 109 of each retaining arm 103 has an open slot 111 formed therein which is sized for receiving another fastener 113. A central portion 115 of each retaining arm 103 is configured for extending over the peripheral edge margin of the seat 99 (and hence the substrate 23 seated therein) and has a thickness such that the retaining arm engages the substrate to urge the substrate down into the seat during operation of the device 27.

To secure a substrate 23 on the device 27, the fasteners 113 at the free ends 109 of the arms 103 are loosened and the arms are pivoted out to an open position (e.g., as shown by one arm in FIG. 6) in which the arms do not extend over any portion of the seat 99 formed in the upper surface of the support plate 97. The substrate 23 is then placed in the seat 99 and the arms 103 are pivoted inward to a closed position (e.g., as shown by the other arm in FIG. 6) in which the shafts of the loosened fasteners 113 are received in the slots 111 formed in the free ends 109 of the arms 103. In their closed position, the central portions 115 of the retaining arms 103 extend over a peripheral edge margin of the seat in engagement with the substrate 23 seated therein. The fasteners 113 at the free ends 109 of the arms 103 are then tightened, causing the central portions 115 of the retaining arms 103 to generally urge the substrate 23 down into the seat 99 to inhibit movement of the substrate during operation of the device 27.

It is understood that linear reciprocation of the substrate 23 along a path normal to the substrate surface 29 may be performed with other conventional linear reciprocating devices having drive systems other than an electromagnetic drive system. It is also understood that movement devices capable of reciprocating the substrate along an axis other than normal to the substrate surface are known in the art and may be used without departing from the scope of this invention. For example, a movement device in which the substrate is reciprocated generally in the plane of the substrate surface (e.g., side-to-side) may be used. Devices in which a combination of reciprocating movements within and out of the plane of the substrate supported thereby, such as a device in which the substrate is rocked back and forth on an arcuate path, may be used. It is also contemplated that a movement device in which the substrate is rotated, such as the spin-coating device of FIG. 1, may be adapted to oscillate the substrate back and forth about the rotation axis of the device (e.g., first in one direction and then in another) and remain within the scope of this invention.

The movement device 27 may also move the substrate 23 in different ways, either sequentially or concurrently, such as by reciprocating the substrate up and down while the substrate is moved in an orbital path or rotated, or by varying the operating parameters of the movement device, such as to vary the speed (e.g. rotational speed or frequency) or displacement (e.g., amplitude or orbital path) of the substrate, during operation of the device.

The apparatus 21 of this third embodiment may also comprise a control system (not shown but similar to the control system 57 shown in FIG. 1) for controlling the drive system of the reciprocating movement device 27. For example, the control system may be used to monitor and control the drive system 83 start time, the amplitude and frequency of the device, the duration of operation of the drive system and other relevant parameters. It also contemplated that a heater (not shown but similar to the heater 353 shown in FIG. 21 and described later herein) or a cooling device (not shown) may be used to heat or cool the substrate 23 and/or liquid samples during operation of the reciprocating movement device 27.

In operation, a substrate 23 is seated in the holder 85 of the linear reciprocating device 27 in the manner described previously, with the mirror-finish surface 29 of the substrate exposed (e.g., facing up in the device shown in FIG. 6). The deposition device 25 is then operated to deposit one or more liquid samples on the exposed substrate surface 29. The liquid samples may be deposited serially, such as by the device 25 shown in FIG. 1, or simultaneously, such as by a deposition device (not shown) having multiple probes. It is contemplated that if only one liquid sample is deposited on the substrate surface 29, it may be located offset from the center of the substrate. In the event more than one liquid sample is deposited on the substrate surface 31, the liquid samples are preferably deposited thereon in spaced relationship with each other, with the samples all being generally offset from the center of the substrate or with one of the samples being deposited at the center of the substrate.

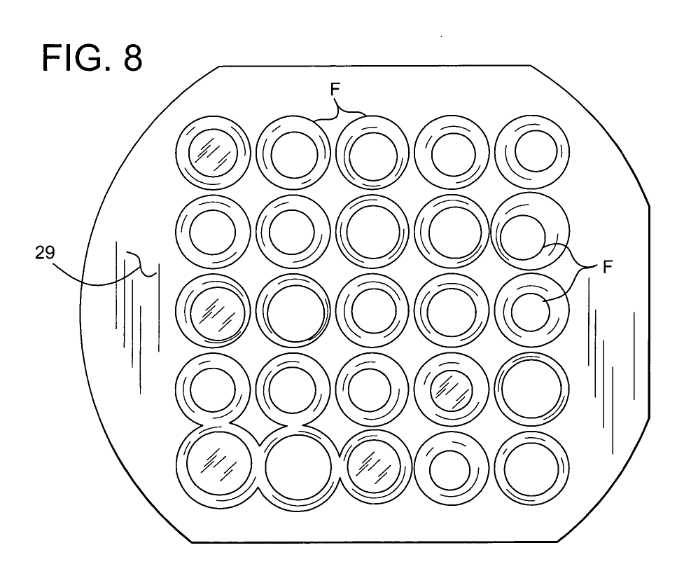

The reciprocating movement device 27 is then operated to effect a linear reciprocating movement of the substrate 23, such as up and down for the device shown in FIG. 6. Linear reciprocation of the substrate 23 subjects the liquid samples to a non-contact spreading force (e.g., due to acceleration), resulting in a shear stress at the liquid sample/substrate surface interface. When sufficiently large, this shear stress causes the liquid samples to spread or flatten on the substrate surface 29 to facilitate thinning of the liquid and evaporation thereof to thereby form corresponding thin films on the substrate surface. Linear reciprocation of the substrate 23 facilitates a more controlled spreading or flattening of the liquid sample on the substrate surface 29. For example, the vertical reciprocating movement of the substrate by the device 27 of the illustrated embodiment causes each liquid sample to spread or flatten on the substrate surface 29 in a generally circular pattern to form generally circular films F on the substrate 23, as shown in FIG. 8.

The liquid samples are preferably deposited on the substrate surface 29 with sufficient spacing there between such that the films formed on the substrate surface remain discrete from each other. However, it is understood that portions of adjacent films may overlap each other and remain within the scope of this invention, as along as a portion of each film remains sufficiently discrete from other films on the substrate surface 29 to permit the desired screening of each different film. For example, an area of at least about 0.1 mm² of each film formed on the substrate surface 29 is preferably discrete from other films formed thereon. It also contemplated that the liquid samples may alternatively be deposited on the substrate surface 29 during operation of the reciprocating movement device 27 so that the substrate surface 29 is already moving as liquid samples are deposited thereon.

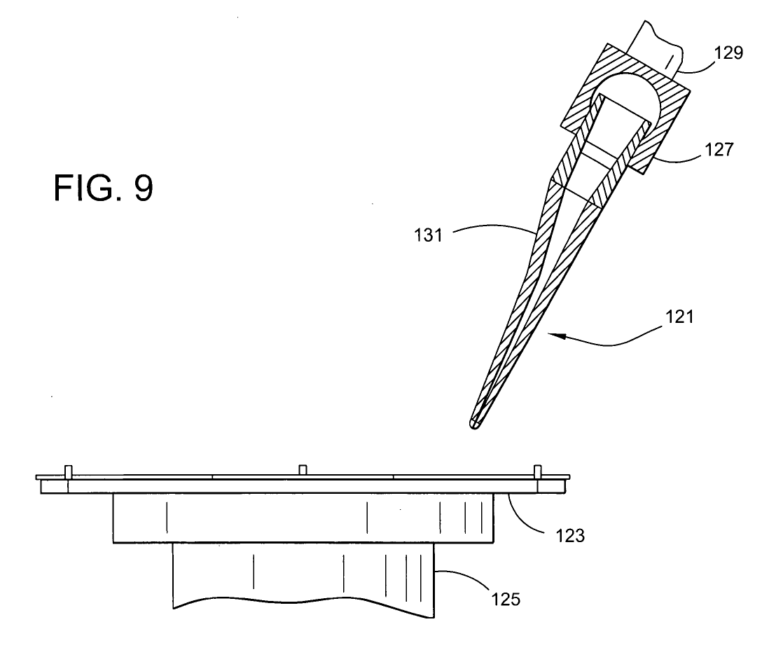

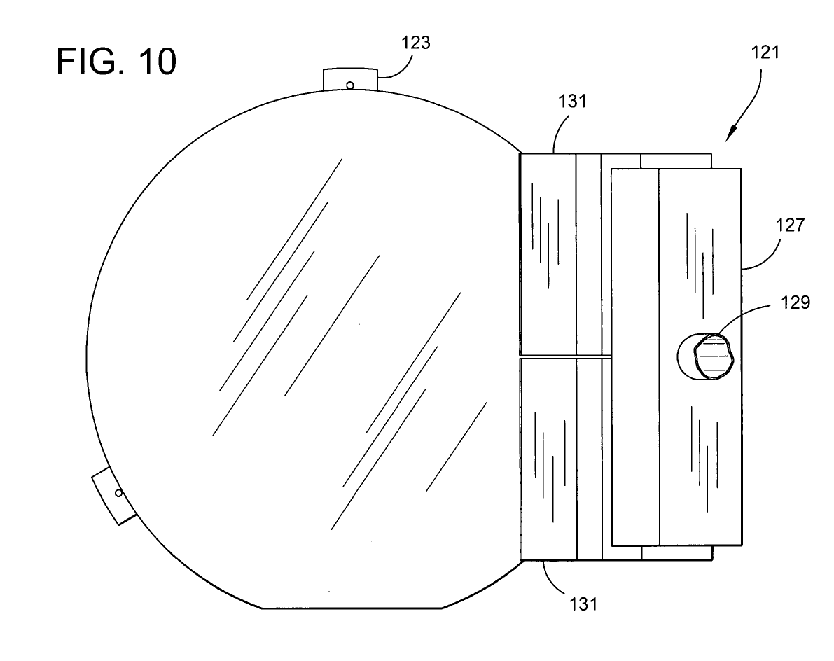

FIGS. 9 and 10 illustrate a portion of a fourth embodiment of an apparatus 21 suitable for use in the present invention in which a spreading force is applied to the liquid samples by pressurized gas, such as air, directed toward the substrate 23 by an air knife (broadly, a gas delivery device), generally indicated at 121. The substrate 23 is supported by a suitable holder 123 mounted on a stand 125, and the air knife 121 is positioned above the substrate at a distance of from about 1 mm up to about 100 mm. The air knife 121 comprises a manifold 127 in fluid communication with a source (not shown) of pressurized gas via a suitable gas line 129, and one or more nozzles 131 (two are shown in FIG. 10) secured to the manifold for receiving pressurized gas and directing the gas down toward the substrate surface.

Gas supplied to the nozzle(s) 131 is preferably at a pressure in the range of from about 1 psi to about 100 psi, and more preferably in the range of about 5 psi to about 20 psi. The nozzles 131 are preferably oriented to direct pressurized gas down toward the substrate surface 29 at an impact, or incident angle in the range of about 0° to about 90°, more preferably in the range of about 10° to about 80°, and most preferably in the range of about 30° to about 60°. General construction and operation of air knives is known in the art and will not be further described herein except to the extent necessary to describe the present invention. As an example, one preferred air knife 121 is available from Silvent of Sweden under the model designation 392 and comprises a pair of generally flat nozzles. Other conventional air knives 121 are shown and described in U.S. Pat. Nos. 2,135,406 and 5,505,995, the entire disclosures of which are incorporated herein by reference.

It is contemplated that the air knife 121, or an array of air knives (such as in the case wherein multiple films are to be prepared using multiple substrates, for example during overlapping periods of time) may be moveable relative to the substrate 23 during operation of the air knife to vary the direction at which air impacts the substrate surface (and hence the liquid samples deposited thereon). Also, the substrate 23 may be moveable instead of, or in addition to, the air knife 121, such as by being rotated or moved laterally relative to the air knife, without departing from the scope of this invention.

In operation, a substrate 23 is supported by the holder 123 with the mirror-finish surface 29 of the substrate exposed (e.g., facing up in the device 27 shown in FIG. 9). The deposition device 25 is then operated to deposit one or more liquid samples on the exposed substrate surface 29. The liquid samples may be deposited serially, such as by the device shown in FIG. 1, or simultaneously, such as by a deposition device having multiple probes. It is contemplated that if only one liquid sample is deposited on the substrate surface 29, it may be located offset from the center of the substrate. In the event more than one liquid sample is deposited on the substrate surface 29, the liquid samples are preferably deposited thereon in spaced relationship with each other, with the samples all being generally offset from the center of the substrate or with one of the samples being deposited at the center of the substrate.

The air knife 121 is then operated to direct pressurized gas toward the substrate surface 29 to impact the liquid samples. The pressurized gas impacting the liquid samples subjects the liquid samples to a spreading force, resulting in a shear stress at the liquid sample/substrate surface interface. When sufficiently large, this shear stress causes the liquid samples to spread or flatten on the substrate surface 29 to facilitate thinning of the liquid and the gas flow further facilitates evaporation of the liquid samples to thereby form corresponding thin films on the substrate surface.

The liquid samples are preferably deposited on the substrate surface 29 with sufficient spacing there between such that the films formed on the substrate surface remain discrete from each other. However, it is understood that portions of adjacent films may overlap each other and remain within the scope of this invention, as along as a portion of each film remains sufficiently discrete from other films on the substrate surface 29 to permit the desired screening of each different film. For example, an area of at least about 0.1 mm² of each film formed on the substrate surface 29 is preferably discrete from other films formed thereon.

It is contemplated that liquid samples on the substrate 23 may be subjected to non-contact spreading forces other than by the movement devices 27 described previously or by the air knife 121 without departing from the scope of this invention. For example, liquid samples may be dispensed onto the substrate 23 and the substrate may be tilted, or the substrate may be tilted prior to the- delivery of liquid samples thereon, such that the liquid samples on the substrate are subjected to a gravitational force sufficient to spread the liquid samples on the substrate surface 29. The tilt of the substrate 23 may also be varied as the liquid samples spread over the substrate surface 29.

FIGS. 11 -19 illustrate yet another embodiment of apparatus suitable for use in the present invention for forming films on substrates. More particularly, apparatus of this embodiment, generally designated 221, effects the parallel formation of films on an array of substrates 223 each having the characteristics described above. However, each of the substrates 223 on which the films are formed by apparatus 221 of this embodiment are substantially smaller, such as preferably having a surface area of no greater than about one square inch, and more preferably a surface area of about 0.25 in.². In the embodiment shown, the substrates 223 are held by holders, each of which is generally indicated at 251. The apparatus 221 also includes a drive system, generally designated 253, operable for moving at least two of the substrates 223 (and preferably all of the substrates) of the array during overlapping durations of time to subject samples deposited on the substrates to non-contact spreading forces to thereby cause the samples to spread over the respective surfaces of the substrates to form films on the surfaces. The drive system 253 is preferably under the control of a programmable control system, generally designated 255, which controls the drive system to move the substrates 223 according to a predetermined program.

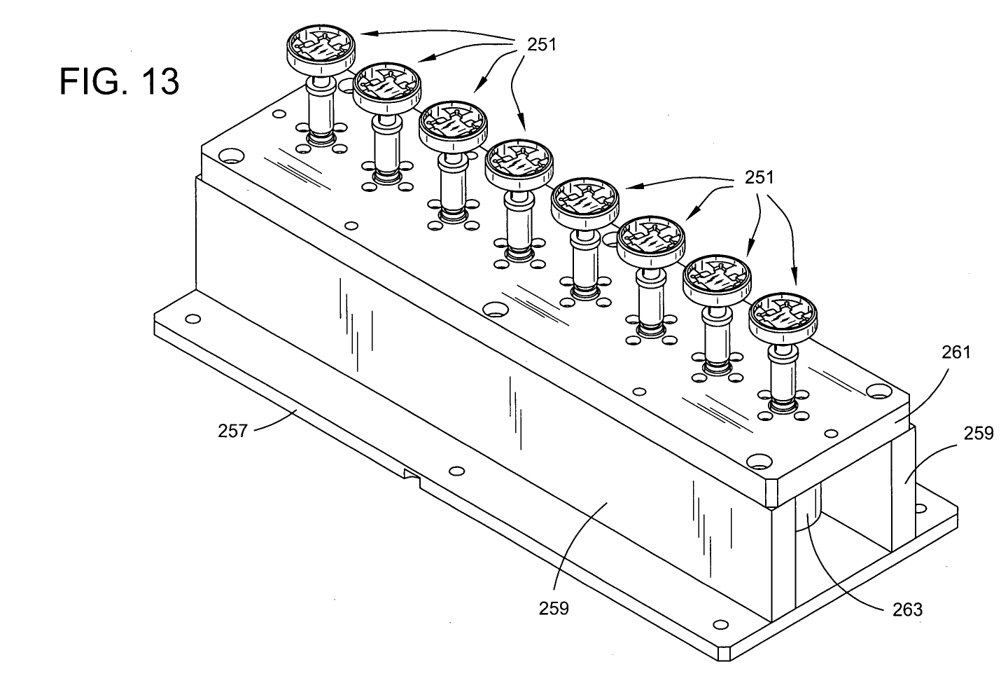

In the particular embodiment shown, the aforementioned drive system 253 is mounted on a frame having a base 257, side walls 259 extending up from the base, and a top wall 261 which spans the side walls (FIG. 13). The drive system 253 includes at least one and preferably a plurality of electric motors 263, one per substrate 223, mounted below the top wall 261 of the frame by suitable fasteners. An output shaft 265 of each motor 263 projects up into a hole 267 through the top wall 261 of the frame and is connected to a respective substrate holder 251 by a shaft assembly comprising a cylindric rotor and drive shaft designated 269 and 271, respectively. The rotor 269 is secured, as by a press fit, on the output shaft 265 of the motor 263 and has an outside dimension smaller than the hole 267 in the top wall 261 to provide the clearance necessary for the rotor to freely rotate as it is driven by the output shaft 265 of the motor. The drive shaft 271 has a lower end 273 of reduced diameter press fit (or otherwise secured) in the upper end of the rotor 269 and an upper end 275 of reduced diameter formed with a bore 277 which extends down into the body of the drive shaft.

The drive shaft 271, rotor 269 and output shaft 265 of the motor 263 preferably have a common vertical axis of rotation. The spacing between adjacent motors 263 and drive shaft assemblies will depend primarily on the size of the holders 251, which in turn will depend on the size of the substrates 223 to be held by the holders. In general, however, the centerline spacing between adjacent drive shafts 271 is preferably in the range of about 1 mm to about 500 mm, more preferably in the range of about 10 mm to about 100 mm, and even more preferably in the range of about 20 mm to about 80 mm. The construction of the drive shaft assembly may vary. For example, the rotor 269 and drive shaft 271 could be formed as a single piece, or as more than two pieces.

Given that the substrates 223 and holders 251 are relatively small in size, the motors 263 can also be relatively small. For example, each motor 263 may be a DC electric motor having a power output of about 3.5 W, a maximum speed of about 7000 rpm, a continuous torque of about 4.95 mNm and a stall torque of about 15.5 mNm. Other types of motors may also be used.

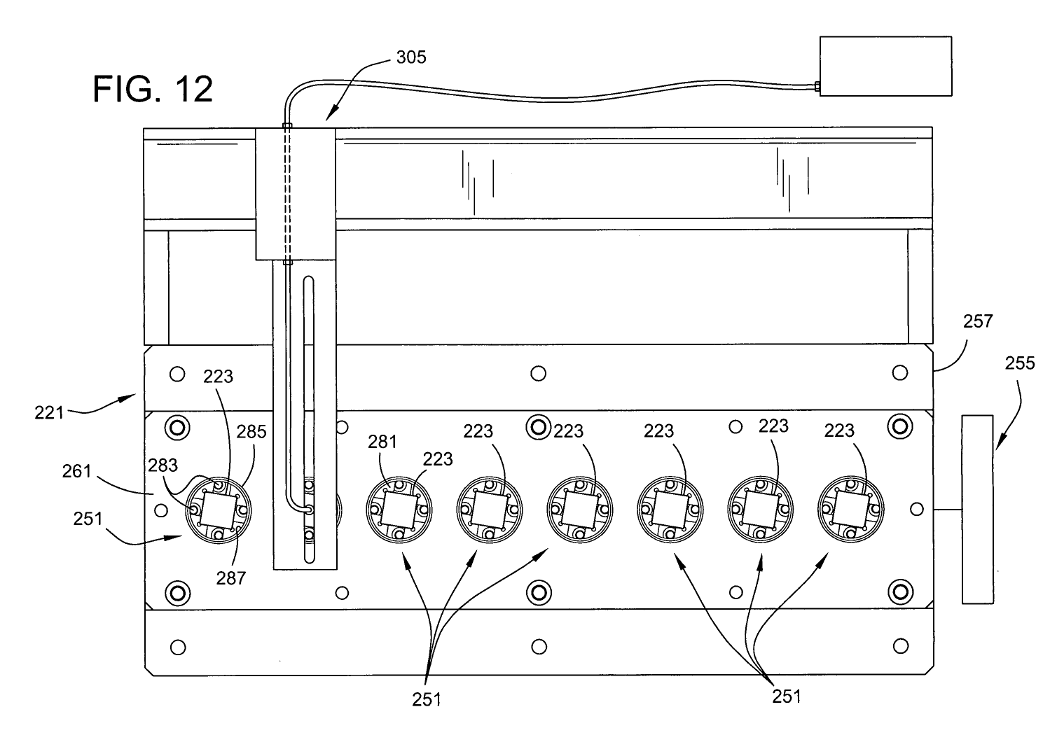

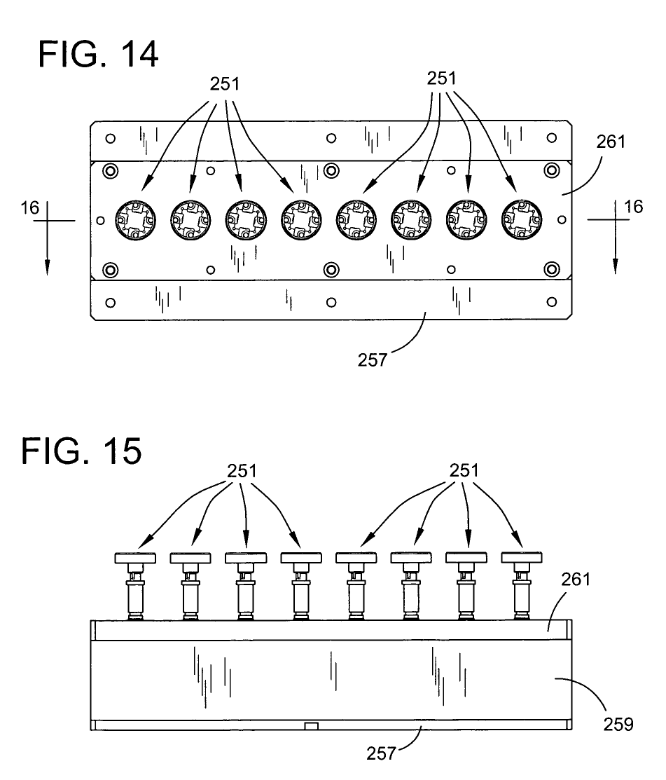

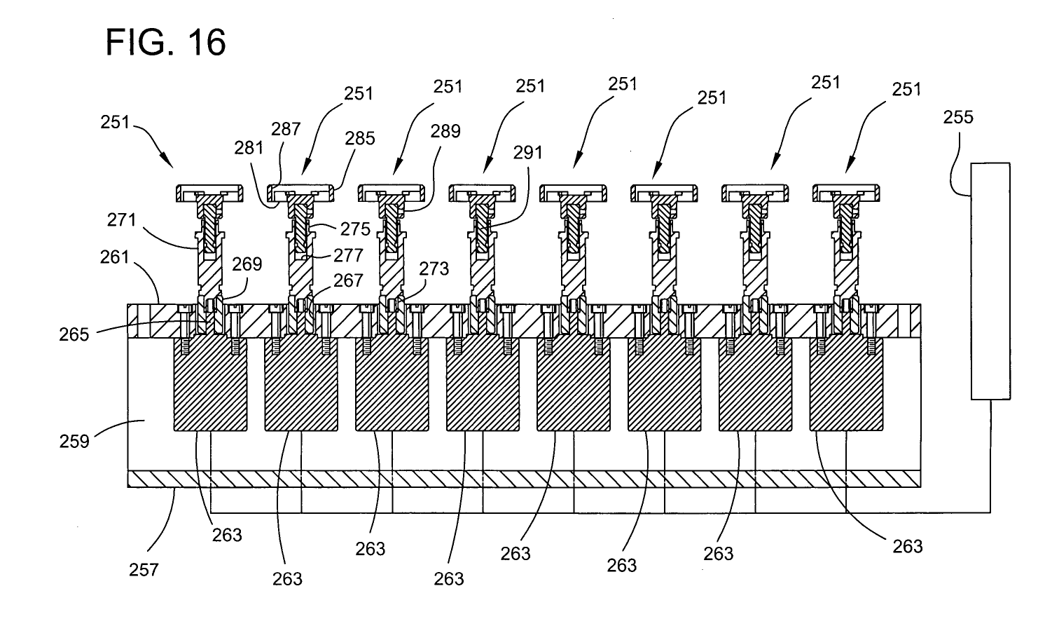

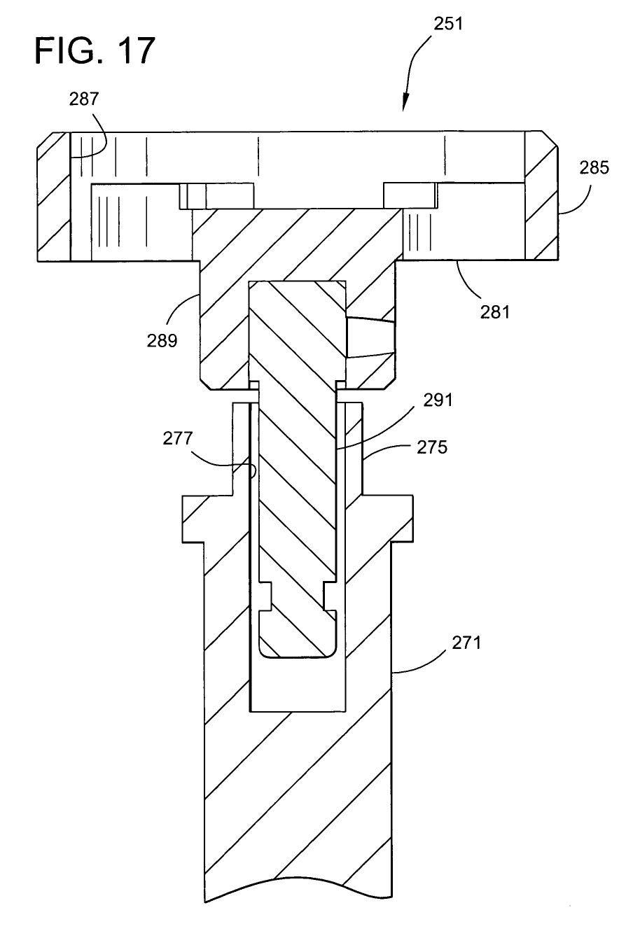

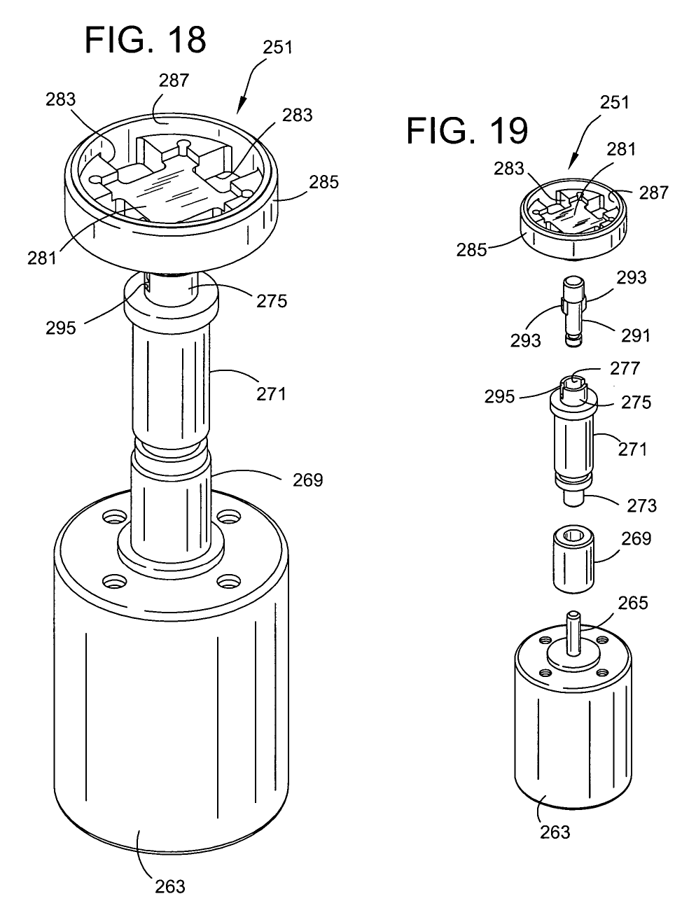

In the particular embodiment of FIGS. 11-19, each substrate holder 251 has a base 281 with openings 283 therein adjacent the periphery of the base, a circular rim 285 extending up from the base, and a recess 287 or depressed area in the upper surface of the base for receiving a substrate 223 therein. The recess 287 is sized and shaped to hold the substrate 223 in a substantially fixed position against lateral movement during rotation of the drive shaft 271. A central hub 289 projects down from the base 281 generally co-axially with respect to the respective drive shaft assembly. The hub 289 and drive shaft 271 are removably and drivingly connected by a connector 291 having an enlarged upper end received and secured (as by a press fit) in an opening in the hub and a lower end received and secured (as by a press fit) in the bore 277 in the drive shaft. The connector 291 is formed with one or more keys 293 receivable in keyway slots 295 extending down from the upper end 275 of the drive shaft 271 to prevent relative rotation of the drive shaft and the connector. The construction of the holder 251 and connector 291 may vary. For example, the holders 251 may have a construction similar to that of the holders 53, 65, 85, 123 of the various embodiments discussed above.

The substrates 223 are typically held in their respective seats by gravity and friction. Where necessary, other mechanisms can be used, such as vacuum, mechanical retainers, or other suitable means.

The number of substrate holders 251 and substrates 223 in the array may range from 2 to 96 or more. The configuration of the array may also vary. For example, the array shown in the drawings includes eight holders 251 and associated components, all arranged in the form of a 1×8 matrix. However, the holders 251 could be arranged in a matrix having any number of columns and rows, or they could be arranged in a geometric formation (e.g., a circle), or even randomly, without departing from the scope of this invention. For efficiency of space, it is preferred that the substrate holders 251 (and substrates 223 therein) be relatively closely spaced in an array which occupies an area (i.e., footprint) having a maximum dimension of less than about five feet by five feet, and more preferably occupies an area of about 1000 mm by about 300 mm, and even more preferably an area of about 100 mm by about 30 mm. If a robotic deposition system 225 is used to deposit samples on the substrates 223, the array is generally confined to an area capable of being serviced by the robot system. By way of example, the footprint of the array shown in FIG. 13 is generally rectangular, having a length of about 300 mm and a width of about 125 mm.

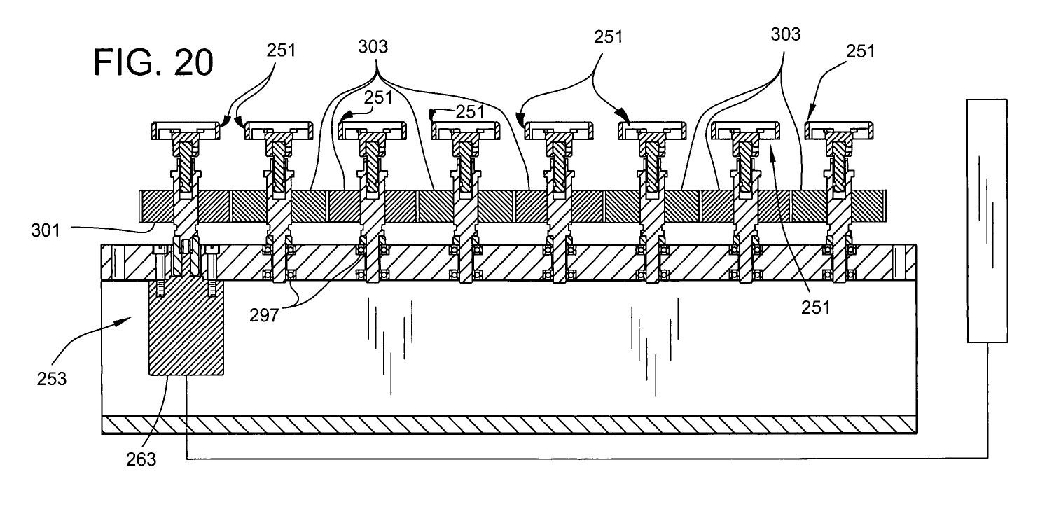

It is contemplated that the drive system 253 could have configurations other than those described above without departing from the scope of this invention. For example, the motors 263 could be mounted on multiple frames instead of a single common frame. Further, the motors 263 can be mounted so that their axes are other than vertical. A single motor 263 can also be used to move more than one substrate 223, as exemplified by the system 253 shown in FIG. 20. In this embodiment, a single motor 263 is drivingly connected to more than one (e.g., all) of the drive shaft assemblies, as by a gear 301 on the corresponding drive shaft 271 in mesh with a gear train comprising a plurality of gears 303 attached to the remaining drive shafts. In this embodiment, the drive shafts 271 are rotatably supported by suitable bearings 297 in the frame. The arrangement is such that rotation of the drive shaft 271 by the motor 263 causes the other drive shafts and associated holders 251 to rotate in unison.

Also, the drive system 253 can be operable to move the holders 251 in ways other than unidirectional movement. As described previously, other drive mechanisms can be employed to effect oscillatory movement, such as orbital movement, reciprocating movement (linear or otherwise) or rocking movement, or other forms of movement effective for subjecting liquid samples on the substrates 223 to non-contact spreading forces. By way of example, an array of holders 251 mounted on a common frame may be operably secured to the orbiting member of an orbital movement device similar to that shown in FIGS. 3 and 4, so that operation of the device effects orbital movement of the entire array of holders and substrates 223 held thereby. Alternatively, each holder 251 can be mounted on a separate orbital movement device. The drive system 253 can also be operable to move two or more of the substrates 223 in different ways, such as through different types of movement (e.g., rotational, orbital, linear) or at different rates and displacements.

The control system 255 for controlling the drive system 253 is preferably a computer based system capable of sending data to the drive system and receiving data from the drive system to monitor and control the operation of the system. Such data preferably includes, for each motor 263, a motor start time, amplitude and/or frequency of movement, duration of motor operation, and any other relevant parameters. The control system 255 is also programmable to permit a pre-determined parameter profile, such as a rate of acceleration, duration of operation, rotational speed and stop time to be pre-programmed. For example, the control system 255 may be programmed such that following deposition of one or more liquid samples on each substrate 223, the particular substrate is subjected to rotation for an initial time period, such as about 5 - 10 seconds, at a relatively low rotational speed, such as about 500 rpm, to promote spreading of the liquid samples on the substrate. The substrate 223 may then be accelerated to a higher rotational speed, such as about 2000 rpm for a longer duration, such as about 40 seconds, to promote further evaporation of the liquid. The system 255 can be used to control the operation of each motor 263 independent of the operation of the other motors (if more than one motor is used), so that different substrates 223 can be subjected to different movement conditions during the same run of experiments occurring during overlapping durations of time. It is believed that the hardware and software components of the control system 255 will be readily apparent to those of ordinary skill in this field and therefore will not be described in more detail.

Liquid samples may be deposited on the substrates 223 manually, or more preferably, by the robotic deposition system 225. It is also contemplated that a robotic system (not shown) may be provided for automatically (instead of manually) mounting the substrates 223 on and removing the substrates from the substrate holders 251 without departing from the scope of this invention.

FIG. 21 illustrates yet another embodiment of an apparatus 321 suitable for use in the present invention which is similar to the apparatus 221 of FIG. 11 but with a heating system, generally designated 351, positioned above the substrates for heating the substrates and the liquid samples deposited thereon. The heating system 351 of the illustrated embodiment comprises an infrared heater 353 positioned a distance of about 1 mm up to about 100 mm above the substrate. The heater 353 is preferably capable of generating heat at a temperature in the range of about 30° C. to about 500° C., more preferably in the range of about 50° C. to about 450° C., and most preferably in the range of about 100° C. to about 400° C. As an example, one preferred such heater 353 is a flat panel infrared heater available from Ogden of Arlington Heights, Ill. under the model designation FP2017 and is operable to generate heat at a temperature of up to about 200° C. If desired, a separate heater may be provided above each substrate holder 251 so that the temperature of one substrate 223 can be varied relative to the temperatures of the other substrates. The heating system can also be under the control of the control system 255 described above. It is also contemplated that a cooling device (not shown) may used instead of the heater 353 where cooling of the substrates 223, ambient environments or liquid samples is desired.

The apparatus 221, 321 described above can be used for forming thin films in the same manner previously described, the only differences being that liquid samples are deposited on more than one substrate 223, and more than one substrate is moved during overlapping durations of time. Liquid samples of the same or different composition and/or volume may be deposited on different substrates 223 and at the same or different locations on different substrates. Further, different numbers of samples may be placed on different substrates 223 (e.g., one sample on one substrate and more than one sample on other substrates), and the conditions under which the films are formed may be varied by varying the amplitude and/or frequency of movement(s), the duration of movement, etc. This is facilitated in certain embodiments by the use of the control system 255 described above. If a heater 353 or cooling device is used, the temperatures of the substrates 223 may also be controlled.

The films, once formed on the substrates, are then subjected to one or more testing processes to determine, measure, screen or characterize various properties of the films, as further described herein below. In this regard it is to be noted that the construction and operation of the screening devices described herein are well known in the art and will not be further described herein. Moreover, it is contemplated that other conventional screening devices may be used to screen the films formed on the substrate, including devices capable of screening for properties other than those described herein, without departing from the scope of this invention.

C. Film Measuring/Testing/Screening

It is to, be noted that, as used herein in reference to an array or library, “screening” generally refers to testing or measuring a library for one or more properties or compounds or materials; that is, “screening” generally refers to measuring one or more properties of interest of a library member (e.g., a parent or daughter array or library compound or material, or a product array or library film), in order to ultimately determine if that member meets a pre-determined criterion. Accordingly, it is to be further noted that, in some instances, a compound or material or film may be (i) measured by a given technique, the data from this measurement being collected and stored, and optionally being reviewed at some later point in time for purposes of comparison with a particular criterion, or (ii) measured by a given technique which includes with it the step of comparing the data of this measurement with a particular criterion, and wherein only the data for the compound or material which meets this criterion is stored for future consideration.

A primary screen or test, when utilized, is typically one that is performed on the members of the parent array or library or product (e.g., thin film) library initially, in order to collect data sufficient to determine, for example, whether the compound or material of interest was formed or is present in the library. Essentially any test method may be primary; however, the purpose of having such a test is to eliminate a member of the array or library from further consideration, and thus more detailed testing. In those instances wherein a primary test is used, a secondary test may be one performed on, for example, the thin films formed from the materials of the parent and/or daughter libraries which passed the primary test.

In this regard it is to be noted, however, that in an alternative embodiment, multiple parent arrays or libraries of compounds or materials are preferably prepared and used to generate or form multiple product libraries, which are then subjected to multiple tests or measurements. In this way, a large database can be generated which can be used in many different ways to collect useful information (e.g., to identify compounds or films for further study or use). This approach is described further herein below.

Among the several properties for which the films of the present invention can be tested are included, for example, various electrical, thermal, mechanical, chemical, morphological, optical, magnetic, etc. properties listed in Table 1, below:

TABLE I
EXAMPLES OF PROPERTIES FOR WHICH
COMPOUNDS AND FILMS CAN BE TESTED

| | |
|---|---|
| ELECTRICAL: | CONDUCTIVITY |
| | RESISTIVITY FOR RESISTIVE FILMS |
| | DIELECTRIC CONSTANT |
| | DIELECTRIC STRENGTH |
| | DIELECTRIC LOSS |
| | ELECTROMIGRATION |
| THERMAL: | COEFFICIENT OF EXPANSION |
| | THERMAL CONDUCTIVITY |
| | TEMPERATURE VARIATION |
| MECHANICAL: | STRESS |
| | ANISOTROPY |
| | ADHESION |
| | HARDNESS |
| | DENSITY |
| | DUCTILITY |
| | ELASTICITY |
| | POROSITY |
| MORPHOLOGY: | CRYSTALLINE OR AMORPHOUS |
| | MICROSTRUCTURE |
| | SURFACE TOPOGRAPHY |
| OPTICAL: | REFRACTIVE INDEX |
| | ABSORPTION |
| | BIREFRINGENCE |
| | SPECTRAL CHARACTERISTICS |
| | DISPERSION |
| | FREQUENCY MODULATION |
| | EMISSION |
| MAGNETIC: | PERMEABILITY |
| CHEMICAL: | COMPOSITION |
| | ACIDITY-BASICITY |
| | IMPURITIES |

The properties listed in Table I can be tested for or measured using conventional methods and devices known to and used by those of skill in the art. Scanning systems which can be used to measure for the properties set forth in Table I include, but are not limited to, the following: scanning Raman spectroscopy; scanning NMR spectroscopy; scanning probe spectroscopy including, for example, surface potentialometry, tunnelling current, atomic force, acoustic microscopy, shearing-stress microscopy, ultra fast photo excitation, electrostatic force microscope, tunneling induced photo emission microscope, magnetic force microscope, microwave field-induced surface harmonic generation microscope, nonlinear alternating-current tunneling microscopy, near-field scanning optical microscopy, inelastic electron tunneling spectrometer, etc.; optical microscopy in different wavelengths; scanning optical ellipsometry (for measuring dielectric constant and multilayer film thickness); scanning Eddy-current microscope; electron (diffraction) microscope, etc.

In certain particularly preferred embodiments, such as wherein low dielectric materials are used to form thin films, as further described herein below, products library members are screened using one or more, and preferably all, of the following techniques:

1. Optical inspection, in order to determine for example the refractive index (n) and thickness of the film, as well as the extinction coefficient (which is a measurement of the amount of light absorbed by the film). In one preferred technique for measuring the thickness of the film, commonly referred to as profilometry, the thickness of the film is determined using a stylus in physical contact with the film. One machine for making such determinations the film thickness in such a manner is available from KLA/Tencor Corp. of San Jose, Calif., U.S.A. under the model designation P-15. Alternatively, an n&k Analyzer 1500/1512, commercially available from n&k Technology (Santa Clara, Calif.), can be used, which collects optical spectra and then, using “goodness of fit,” compares the spectra to models to extract the refractive index and thickness of each spectra collected.

2. Electrical inspection, in order to determine for example the dielectric constant (by measuring the capacitance and thickness). One device for determining dielectric constant is commercially available from Solid State Measurements Inc. (Pittsburgh, Pa.), under the model designation SSM 495. This device measures the capacitance of a film and, based on the thickness of the film (e.g., as determined by using the techniques described previously), determines the dielectric constant thereof. To use such a device, the films formed on the substrate are each preferably sized to have a surface area of at least about 3 mm².

3. Mechanical inspection, in order to determine for example hardness and Young's modulus of elasticity for each film. A preferred technique for such determinations is commonly referred to as nanoindentation, wherein a diamond tip is driven down into the film and the resistance of the film to indentation by the diamond tip is measured. One preferred device for carrying out such a screening is available from Hysitron Inc. (Minneapolis, Minn.) and designated as a triboindentor nanomechanical test system. To use such a device, the films formed on the substrate are each preferably sized to have a width and length (or diameter) of at least about 50 nm to about 100 nm.

4. Visual inspection is not required in all cases. However, experience to- date suggest such a test is helpful in order to identify, for example, films formed from good coating or spreading techniques (e.g., to identify films that did not spread evenly or fully, such that a sufficiently large surface area for screening has been formed).

D. Film Properties

As previously noted, in some embodiments, the thickness of the films (e.g., dielectric films) may range from about 50 Å to about 100 μm, or preferably from about 1,000 Å to about 10,000 Å. In addition, a portion of the surface area of each film formed on the substrate preferably has a substantially uniform thickness to facilitate more accurate screening of the film, this portion having a thickness which is uniform to within a variation of less than about 20%, 10%, 5%, 3%, 2% or even 1%, with the most preferred being substantially no variation (the thickness uniformity ranging, for example, from about 0% to about 20%, preferably from about 0% to about 10%, more preferably from about 0% to about 5%, and most preferably from about 0% to about 3%). Furthermore, the size (e.g., surface area) of a region within each film formed on the substrate surface is preferably at least about equal to the minimum size used by the measurement method to characterize the film, and is more preferably up to about three times larger than this minimum size.

In this regard it is to be noted that film thickness, uniformity and/or size (i.e., surface area) may be other than herein described without departing from the intended scope of the present invention.

The dielectric films of the invention are also preferably mesoporous. The term “mesoporous”, as used herein, describes pore sizes that range from about 10 Å to about 500 Å, preferably from about 20 Å to about 100 Å, and most preferably from about 20 Å to about 50 Å. It is also preferred that these film have pores of uniform size, and that the pores are homogeneously distributed throughout the film. Such films also preferably have a porosity of about 50% to about 80%, more preferably about 55% to about 75%. The porosity of the films may be closed or open pore. Furthermore, in certain embodiments of the present invention, the diffraction pattern of the film does not exhibit diffraction peaks.

The dielectric materials of the present invention also preferably have mechanical properties that allow them, when formed into films, to resist cracking and enable them to be chemically/mechanically planarized. Further, the dielectric films of the present invention preferably exhibit low shrinkage. Finally, the dielectric films of the present invention preferably exhibit a modulus of elasticity of between 1.4 and 10 GPa, and more preferably between 2 and 6 GPa; a hardness value between 0.2 and 2.0 GPa, and more preferably between 0.4 and 1.2 GPa; and, a refractive index determined at 633 nm of between 1.1 and 1.5.

The dielectric films of the present invention provide excellent insulating properties and a relatively high modulus of elasticity. Suitable applications for such films include: (i) interlayer insulating films for semiconductor devices, such as LSls, system LSls, DRAMs, SDRAMs, RDRAMs, and D-RDRAMs; (ii) protective films, such as surface coat films for semiconductor devices; (iii) interlayer insulating films for multilayered printed circuit boards; and, (iv) protective or insulating films for liquid-crystal display devices. Further applications include capping layers, hard mask, or etch stops.

E. System For Research

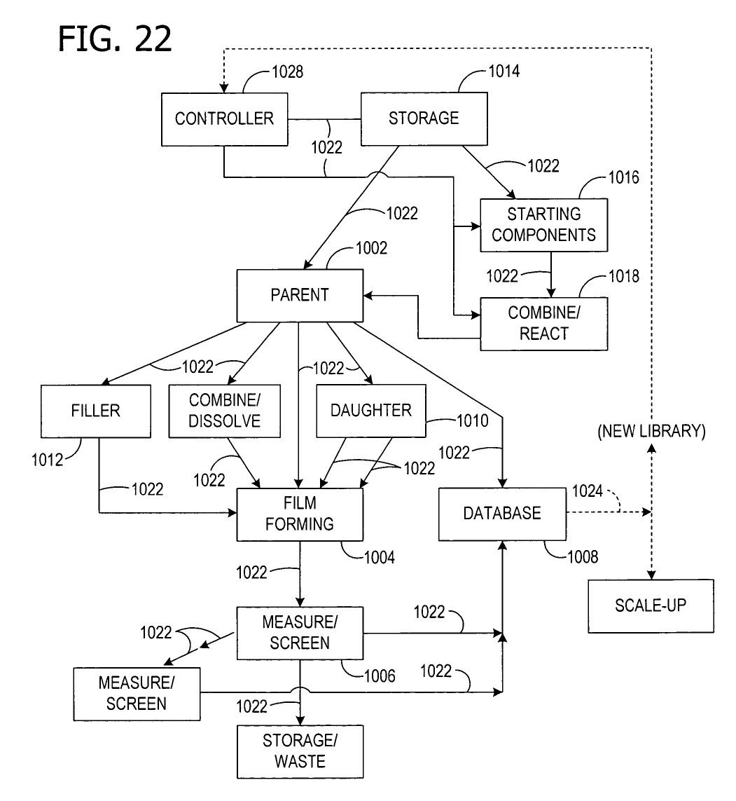

An apparatus or system for researching for thin films is illustrated in FIG. 22. System 1000 includes a parent library 1002, a film-forming apparatus, optionally located as a film-forming station, 1004, a testing or measuring apparatus 1006 and a data collection apparatus, or database, 1008, and optionally a daughtering apparatus 1010 (to create one or more daughter libraries) and/or a filtering apparatus 1012. In addition, the system may include storage apparatus 1014, wherein stored may be one or more of (i) the reactants or starting components 1016 used to prepare the members of the parent library, (ii) materials or compounds ready for use as members of a parent library, and/or (iii) finished parent libraries ready for use. When starting components 1016 are to be used, a combining/reaction apparatus 1018 may be used. Once the parent library has been formed, members may be proceed directly to the film-forming apparatus 1004, or they may (i) pass through a combining/dissolution apparatus 1020, where they are mixed with other components (e.g., a solvent, which may or may not be needed to dissolve the member), (ii) a filtering apparatus 1012, or (iii) a daughtering apparatus 1010 (either directly or after passing through the filtering station). An automated robotic system, represented by arrows 1022, may be used to move libraries from one apparatus or station to another.

In this regard it is to be noted that a given apparatus may serve more than one function; for example, reaction may occur at or within the combining apparatus, once the starting components are combined. Alternatively, however, each function may occur in a separate apparatus, at a separate location within the system. In addition, each apparatus may be individually located at a separate station within the system, or alternatively two or more apparatuses may be located at the same station (e.g., combining and reaction apparatus located at a single combining/reaction station). Accordingly, as used herein, “station” refers to a location within the system whereat one or more functions are performed. The functions may be combining the starting components, creating a parent library via a reaction, forming a film from a member of the parent library, testing or measuring the film or a member of the parent library before film formation, or any of the other functions discussed above. Thus, located at each station may be a liquid handling robot with pumps and computers (as known in the art) to dispense, dissolve, mix and/or move liquids from one container or receptacle to another.

It is to be further noted that the system of the present invention may include any of the reactors discussed above. Additionally, one or more operations or function of the system t may be performed or carried out in an inert atmosphere (using for example a glove box).

Generally speaking, in operation, starting components or parent compound or material libraries, etc. are inputted into the apparatus (or retrieved from storage) and sent either to a combining/reaction apparatus 1018 or directly to the parent library 1002 (if the compound or material was previous prepared). After the parent library is assembled, members may be tested to confirm composition (not shown), and/or filtered and/or daughtered and/or combined/reacted with other components. Ultimately, however, thin films are formed via the film-forming apparatus 1004, using for example various spin-coating techniques described herein. Finally, the resulting films are measured or tested for one or more properties of interest.

FIG. 22 illustrates a block diagram flow for a methodology useful in this invention. Starting components or parent libraries may be maintained in storage and retrieved from storage and moved via the handling system 1022. Optional in this process is the daughtering of the parent library by the daughtering apparatus 1010. Multiple paths are shown from the daughtering apparatus 1010 to the film-forming apparatus 1004 to show the possibility that multiple daughter libraries are prepared and transferred thereto.

In generally, a daughter library is created from the parent library at a daughtering apparatus by taking one or more aliquots from one or more members in the parent library, wherein an aliquot is a definite fraction of a whole. This process is referred to as “daughtering.” Literally, a liquid pipette, operated either manually or automatically (e.g., robotically), draws a bit of a member from the parent library and dispenses that aliquot into another container to give a daughter library member. A limited number of members of the parent library may be daughtered or all the members may be daughtered at least once to create one daughter library. Thus, a daughter library may be smaller than the parent library in terms of either mass, volume or moles and/or in terms of the number of members. In other embodiments, the members of the parent library are maintained in a solid form. During the daughtering process, known solid handling equipment and methods are used to take the aliquot from the parent library to created the daughter library, which will have members that are also solids. Thereafter, it may be necessary to dissolve the members of the daughter libraries in a solvent. Daughtering is performed in order to provide multiple libraries for multiple reactions of interest or multiple screens without having to recreate the parent library.

In one embodiment, prior to daughter or film formation, the compound or material goes to a filtering apparatus 1012, and preferably a parallel filtering apparatus. Since filtering may remove unwanted materials (e.g., solid phase reagents or products) from, for example, the parent library, it may be desirable to daughter the library after filtering (not shown), which is accomplished at a daughtering apparatus 1010 between a filtering apparatus (not shown) and the film-forming apparatus 1004. Process diversity may be accomplished at combining/reaction apparatus 1018 or combining/dissolution apparatus 1020, or using the reaction or other process options discussed herein above. From the film-forming apparatus 1004, the product library proceeds to the screening station 1006, where one or more predetermined screens are run to determine if the operation or action of interest (e.g., film-formation) was successful and/or the qualitative or quantitative degree of success of the operation or action of interest. A testing or measuring station may include a single or multiple apparatuses (such as for a primary/secondary testing approach, or for a multiple testing approach wherein all samples are subject to multiple tests); alternatively, multiple locations (i.e., stations) may be used for the multiple tests.

A feed-back loop 1024 is provided that takes information from, for example, the combining/reaction apparatus 1018 (when a reaction that includes a test or measurement is used to form a parent library member or to collect compositional information) or the testing apparatus 1006 (via the database 1008). The information from the testing apparatus 1006 may be used at the starting component apparatus, the reaction/combining apparatus 10018 and/or the storage apparatus 1014 for the preparation of new parent libraries, or alternatively for the scale-up of a candidate for further study.

In this regard it is to be noted that new libraries may be prepared by means of using different starting components, or alternative by using the same starting components but changing the order in which they are combined (i.e., the order in which the starting components are added to each other). Experience to-date suggests that, in at least some embodiments, the order of addition may be of particular interest and worthy of combinatorial experimentation and study. More specifically, it is to be noted that experience to-date suggests that the order in which starting components are combined can, in some instances, impact the nature of the resulting reaction product and/or the film prepared therefrom. Given that such results are not easily explained or understood, the use of combinatorial experimental techniques are particularly well-suited to study the impact the order of addition may have in a given situation.

The system 1000 includes a computer or processor based system 1028 that controls, monitors and/or coordinates the process steps as well as interaction between the various apparatuses including, for example, 1014, 1016, 1018, and/or 1002. The “control” system also coordinates the movement of receptacles (e.g., plates) which have wells wherein the parent or daughter library members are contained by the robotic system 1022. The “control” system 1028 also includes computers, processors and/or software that a user may use to interact with the system 1000. Ideally, the control system 1028 contains sufficient hardware and software so that it is “user-friendly,” for example so that the amount of input by the user is limited to the essential design and process elements. Ideally, a user of the “control” system 1028 may design a set of experiments to create a product library, specify the test of that product library and command the system to perform all the chemistry and testing automatically from chemicals in storage.

The robotic apparatus 1022 preferably includes an automated conveyer, robotic arm or other suitable device that is connected to the “control” system 1028 that is programmed to deliver the library receptacle or plate (not shown) to respective stations 1020, 1004, etc. The processor is programmed with the operating parameter using a software interface. Typical operating parameters include the coordinates of each apparatus in the system 1000, as well as both the library storage plate and daughter plates positioning locations at each station. Other data, such as the initial compositions of each library member (e.g., parent) may also be programmed into the system.

In some embodiments, a library is stored in a storage receptacle or plate that holds one library separate from another. (See, e.g., U.S. application Ser. No. 09/227,558 entitled “Apparatus and Method for Research for Creating and Testing Novel Catalysts, Reactions and Polymers,” which is incorporated in its entirety herein by reference, FIGS. 3, 6A-6C and 7, along with the accompanying text, to be noted in particular.) The library storage plate may includes a number of wells formed therein that receive vials containing the library members, thus keeping each member separate from the others and in a spatially addressable format on a common substrate. Each vial may be provided with a cap having a septum for protecting the members when being stored. An optional lid having latches for connecting to the storage may also be provided for storage purposes. The library plate may be stored in a rack prior to transfer to the next apparatus, such as a reaction or combining apparatus or a daughtering apparatus. Such libraries may be retrieved from storage either manually or automatically, using known automated robots. Specific robots useful for retrieving such stored libraries include systems such as those marketed by Aurora Biosciences or other known robotic vendors.

In this regard it is to be noted that a parent or daughter library may be stored in a liquid or solid state and retrieved from storage for, in some cases, running in the reaction of interest, daughtering, testing, dissolution and/or combining with other reagents, or combinations thereof. If the compound or material libraries are stored in the solid phase, the members typically require dissolution, which is performed using a dissolution apparatus (not shown), for example.

In one preferred embodiment, a-combining apparatus or a daughtering apparatus includes a daughtering robotic arm that carries a movable probe and a turntable for holding multiple daughter plates while the daughtering step is being performed. The daughtering robotic arm is also movable. The robotic apparatus manipulates the probe using a 3-axis translation system. The probe is movable between vials of reagents or reactants, parent library members, etc. arranged adjacent the parent station, combining/reaction station, etc.

Once the product film libraries are created, the robotic handling apparatus next transports the substrates on which they are formed to a testing or measuring apparatus. This apparatus may be configured to perform multiple tests or measurements using multiple techniques, or alternatively there may be more than one testing or measuring apparatus.

F. Database Preparation and Use

In addition to the method and system or apparatus as described above, it is to be noted that the present invention additionally provides for database, or a collection of data, as well as a method of generating and using that database. More specifically, it is to be noted that, the present invention provides:

1. As previously described, a discovery tool or method wherein a library of material are prepared, formed into thin films, the thin films then being subjected to a series of tests or measurements (e.g., primary, secondary, etc.) which are designed to identify only those candidates which meet specified criteria or a figure of merit at each stage, and continuing to investigate or further test only those that meet such criteria. Stated another way, in one approach, library members are subjected to a primary test in order reduce the number of members that are subjected to a secondary, or more stringent, test. As such, tests and testing criteria are selected with a specific purpose in mind.

2. In contrast, in an alternative and much broader approach, the discovery tool or method is design to generate as much potentially relevant data as possible. As a result, all array or library members, and preferably multiple libraries of members, are subjected to multiple tests or measurements. In this manner, a database of information is created, with the data being capable of defining a landscape. This landscape may be graphically viewed in a three-axis graph, with the axes of the graph having data from the database taken from, for example, composition, figure of merit (or property) and preparation method. For example, one may graph porosity versus silica content versus temperature of curing, in order to determine an optimal material or condition for a particular application.

Stated generally, in the first embodiment, speed of measurement and identification of a sample meeting somewhat narrow criteria is the focus, while in the second embodiment throughput may be sacrificed in order to obtain as much data as possible. However, throughput is in part a function of not only the number of tests performed, but also the types of test performed. Specifically, optical and electrical test methods are more easily automated and, therefore, more easily performed. In contrast, the measurement of mechanical properties is more time consuming, which a reason while mechanical properties are typically measured or tested after optical and/or electrical properties.

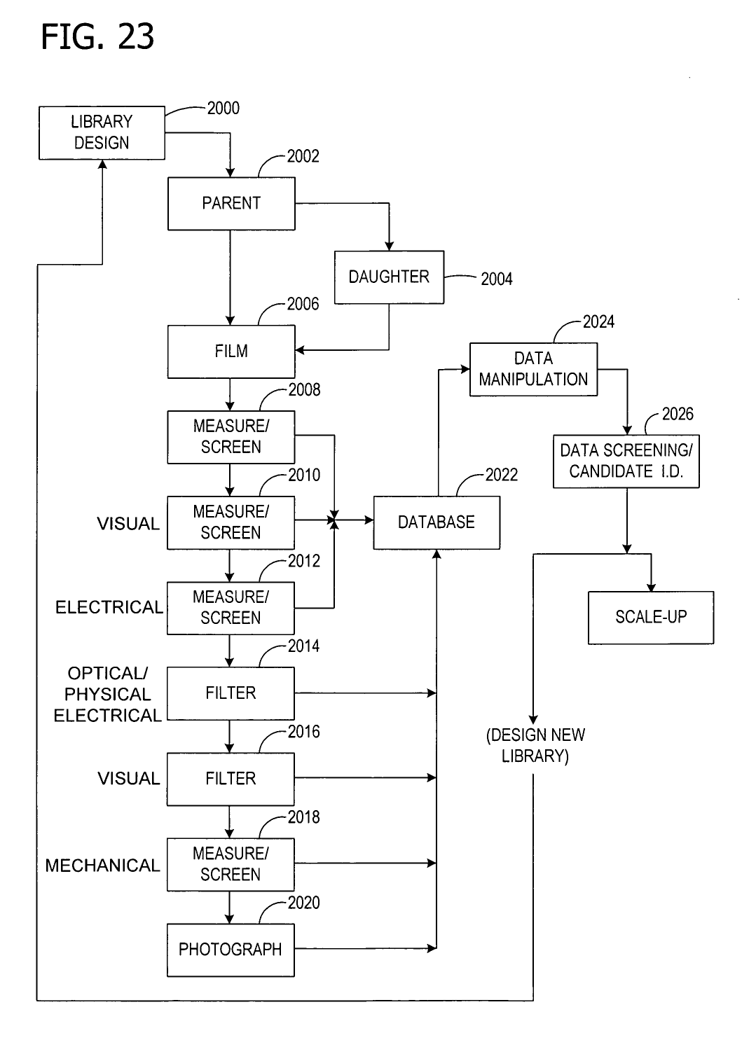

Referring now to FIG. 23, a block diagram which generally illustrates a typical workflow for such a process is shown. Initially, a parent library 2002, and preferably multiple parent libraries (not shown), of compounds or materials are designed, using for example Library Studio® 2000 software (which is available from Symyx Technologies, Inc. of Santa Clara, Calif. and which is published, in part, as WO 00/23921, which is incorporated herein by reference), and prepared (as described elsewhere herein). Once prepared, in order to generate even more samples for study, one or more daughter libraries 2004 may be prepared from the parent library or libraries. In one embodiment, for purpose of studying these parent library members, a product library or libraries 2006 of thin films may be formed. All (or substantially all) of the members of these product libraries (e.g., thin films) are then subjected to multiple tests (e.g., 2008, 2010, 2012), thus generating data sets for each test of data elements for each sample. All of the data from these tests is collected in a database 2022 (e.g., an electronic database), and then optionally correlated with a given sample's process history and/or composition (e.g., reagents and process conditions used to prepare the parent compound or material, as well process conditions used to prepare the film, etc.). Additionally, the database may correlate one data set to one or more different data sets, or data elements within different data sets.

Once this data is collected, in the case of low dielectric thin films, additional tests may be performed or one or more “filters” may be used to review or screen the data and, at this stage, identify candidates worthy of further investigation. Referring again to FIG. 23, an initial filter 2014 may be used to check the goodness of fit of the optical spectra; for those films meeting the set criteria (e.g., goodness of fit of at least about 9850), the thickness and capacitance are used to calculate the dielectric constant for the sample, which is then stored in the database with the rest of the information collected for that sample. (See, e.g., U.S. application Ser. No. 09/755,623 entitled “Laboratory Database System and Methods for Combinatorial Materials Research,” which was filed on Jan. 5, 2001 and which is incorporated in its entirety herein by reference.) All or a portion of the samples may then be subjected to additional filters (e.g., 2016), wherein for example the data collected is reviewed or screened for samples having certain visual qualities and/or dielectric constants.

In this regard it is to be noted that, as used herein in reference to the database or collected data, “screen” means to examine, review or use the collected data to search for or identify a film of interest, such as by comparing a measured property against one or more pre-determined criteria.

For those films which are found to meet or satisfy the criteria used to “filter” all of the samples, additional testing may be used. For example, films found to have a certain minimum visual quality and dielectric constant may be screened for mechanical properties 2018 of interest, such as Young's modulus and hardness. This data is stored in the database, and correlated with the rest of the sample data, as well. Finally, these samples may be digitally photographed and stored 2020.

It this regard it is to be noted that other testing and/or filtering techniques known in the art may additionally, or alternatively, be employed in the present process without departed from its intended scope. For example, thickness may also be determined using a profilometery, ellipsometry or interferometry. Capacitance can be measured by depositing a metal film on top of the sample film of interest and then making electrical measurements.

It is to be further noted that the order in which the screens and/or filters are performed may be other than herein described without departing from the intended scope of the present invention.

The collected data may be further manipulated 2024 (either manually or by means known in the art) to generate or calculate, for example, additional compositional and/or chemical data sets or data elements for correlation. All of this data may then be screened 2026 to identify candidates having particular desirable properties for scale-up 2028 and additional investigation or study; alternatively, data may be used to determine if additional libraries are needed. In addition, because a number of tests are performed, this database may be screened at a later date for a different purpose (e.g., to identify samples having a property of interest which is different from the property for which the sample where initially tested/filtered, or alternatively to identify trends in material compositions, process conditions, film-forming conditions, etc.). As a result, the present invention provides a database that is useful for a number of different purposes.

Using such an approach, the present invention may be used to identify particular compounds, or in this case films, of interest. For example, the present invention is particularly suited for preparing and identifying low dielectric materials, and more specifically identifying films having a thickness of at least about 0.2 microns, a dielectric constant of less than about 2.5, preferably less than about 2.2, and more preferably less than about 2, and a Young's modulus of at least about 2 GPA, and preferably at least about 3 GPa. Particularly preferred embodiments of such films include a film having a thickness of less than about 0.2 microns, and (i) a dielectric constant of less than about 2.5 and a Young's modulus of at least 3 GPa, (ii) a dielectric constant of less than about 2.2 and a Young's modulus of at least 3 GPa, or (iii) a dielectric constant of less than about 2 and a Young's modulus of at least 2 GPa.

G. Definitions/Acronyms

As used herein, the following phrases or terms typically have the given meanings:

Substrate: A material having a rigid or semi-rigid surface. In many embodiments, such as in the case of the substrate upon which a thin film is formed, at least one surface of the substrate will be substantially flat. In the case of the compound or material library, it may be desirable to physically separate synthesis regions in the substrate for different materials with, for example, dimples, wells, raised regions, etched trenches, or the like. In some embodiments, the substrate for the compound or material library will itself contains wells, raised regions, etched trenches, etc. which form all or part of the synthesis regions.

Pre-defined Region: A predefined region is a localized area on a substrate which is, was, or is intended to be used for formation of a selected material and is otherwise referred to herein in the alternative as a “known” region or simply a “region.” The predefined region may have any convenient shape, e.g., linear, circular, rectangular, elliptical, wedge-shaped, etc. In some embodiments, a predefined region and, therefore, the area upon which each distinct material is synthesized or formed is smaller than about 25 cm², preferably less than 10 cm², more preferably less than 5 cm², even more preferably less than 1 cm², still more preferably less than 1 mm², and even more preferably less than 0.5 mm². In most preferred embodiments, the regions have an area less than about 10,000 μm², preferably less than 1,000 μm², more preferably less than 100 μm², and even more preferably less than 10 μm².

Radiation: Energy which may be selectively applied including energy having a wavelength between 10⁻¹⁴ and 10⁴ meters including, for example, electron beam radiation, gamma radiation, x-ray radiation, ultraviolet radiation, visible light, infrared radiation, microwave radiation and radio waves. “Irradiation” refers to the application of radiation to a surface.

Component: “Component” is used herein to refer to each of the individual chemical substances that act upon one another to produce a particular material.

Molecular Solids: Solids consisting of atoms or molecules held together by intermolecular forces. Molecular solids include, but are not limited to, extended solids, solid neon, organic compounds, synthetic or organic metals (e.g., tetrathiafulvalene-tetracyanoquinonedimethane (TTF-TCNQ)), liquid crystals (e.g., cyclic siloxanes) and protein crystals.

Inorganic Materials: Materials which do not contain carbon as a principal element. The oxides and sulfides of carbon and the metallic carbides are considered inorganic materials. Examples of inorganic compounds which can be synthesized using the methods of the present invention include, but are not restricted to, the following: (a) Intermetallics (or Intermediate Constituents): Intermetallic compounds constitute a unique class of metallic materials that form long-range ordered crystal structures below a critical temperature. Such materials form when atoms of two metals combine in certain proportions to form crystals with a different structure from that of either of the two metals (e.g., NiAI, CrBe₂, CuZn, etc.); (b) Metal Alloys: A substance having metallic properties and which is composed of a mixture of two or more chemical elements of which at least one is a metal; (c) Magnetic Alloys: An alloy exhibiting ferromagnetism such as silicon iron, but also iron-nickel alloys, which may contain small amounts of any of a number of other elements (e.g., copper, aluminum, chromium, molybdenum, vanadium, etc.), and iron-cobalt alloys; (d) Ceramics: Typically, a ceramic is a metal oxide, boride, carbide, nitride, or a mixture of such materials. Ceramics are inorganic, nonmetallic, nonmolecular solids, including both amorphous and crystalline materials. Ceramics are illustrative of materials that can be formed and screened for a particular property using the present invention.

Organic Materials: Compounds, which generally consist of carbon and hydrogen, with or without oxygen, nitrogen or other elements, except those in which carbon does not play a critical role (e.g., carbonate salts). Examples of organic materials which can be synthesized using the methods of the present invention include, but are not restricted to, the following: (a) Non-biological, organic polymers: Nonmetallic materials consisting of large macromolecules composed of many repeating units. Such materials can be either natural or synthetic, cross-linked or non-crosslinked, and they may be homopolymers, copolymers, or higher-ordered polymers (e.g., terpolymers, etc.). By “non-biological,” α-amino acids and nucleotides are excluded. More particularly, “non-biological, organic polymers” exclude those polymers which are synthesized by a linear, stepwise coupling of building blocks. Examples of polymers which can be prepared using the methods of the present invention include, but are not limited to, the following: polyethylenes, polypropylenes, other polyolefins, polyacrylates, polymethacrylates, polyacrylamides, polyvinylacetates, polystyrenes, etc.

Organometallic Materials: A class of compounds of the type R-M, wherein carbon atoms are linked directly with metal atoms (e.g., lead tetraethyl (Pb(C₂H₅)₄), sodium phenyl (C₆H₅.Na), zinc dimethyl (Zn(CH₃)₂), etc.).

Composite Materials: Any combination of two materials differing in form or composition on a macroscale. The constituents of composite materials retain their identities, i.e., they do not dissolve or merge completely into one another although they act in concert. Such composite materials may be inorganic, organic or a combination thereof. Included with this definition are, for example, doped materials, dispersed metal catalysts and other heterogeneous solids. “Silica source:” as used herein, is a compound having silicon (Si) and oxygen (O), and possibly additional substituents such as, but not limited to, heteroatoms such as H, B, P, or halide atoms; alkyl groups; or aryl groups. “Alkyl:” as used herein, includes straight chain, branched, or cyclic alkyl groups, preferably containing from 1 to 24 carbon atoms, or more preferably from 1 to 12 carbon atoms. This term applies also to alkyl moieties contained in other groups such as haloalkyl, alkaryl, or aralkyl. The term “alkyl” further applies to alkyl moieties that are substituted.

“Aryl:” as used herein, typically refers to six to twelve member carbon rings having aromatic character. The term “aryl” also applies to aryl moieties that are substituted.

In addition, as used herein, the following acronyms are used in the present application:

| Acronym | Generic Name |
|---|---|
| Silica sources | |
| TAS | Tetraacetoxysilane |
| TEOS | Tetraethoxysilane |
| TMOS | Tetramethoxysilane |
| TBOS | Tetra-n-butoxysilane |
| MTES | Methyltriethoxysilane |
| DMDES | Dimethyldiethoxysilane |
| PTES | Phenyltriethoxysilane |
| FTES | Fluorotriethoxysilane |
| HDTMS | Hexadecytrimethoxysilane |
| MTAS | Methytriacetoxysilane |
| HMDS | Hexamethyldisilazane |
| TEDMDS | Tetraethoxydimethyldisiloxane |
| TMDEDS | Tetramethyldiethoxydisiloxane |
| poly-TEOS | Polydiethoxysiloxane |
| TMCTS | Tetramethylcyclotetrasilane |
| OctaTMA-POSS | Silsesquioxane cube WI 8 TMA+ |
| TSE-POSS | trisilanolethyl-POSS |
| Solvents | |
| PGMEA | propylene glycol methyl ether acetate |
| PGPE | propylene glycol propyl ether |
| Bases | |
| TMAH | Tetramethylammonium hydroxide |

### EXAMPLES

As the following Examples illustrate, the present invention affords a method, as well as a system or apparatus, for the rapid research and discovery of materials suitable for forming thin films which have desirable properties. It is to be understood that the following Examples set forth only one approach (e.g., reagents or reactants, process conditions, steps and equipment, etc.) that may be employed to achieve the desired result. As such, these Examples should not be interpreted in a limiting sense.

### EXAMPLE 1

### Large-Scale Sample Preparation and Spin-Coating

TEOS (22.5 g), MTES (22.5 g), propylene glycol propyl ether (PGPE) (100 g) were mixed together until homogeneous. Purified Triton X-114 (9.7 g) was then added to the solvent/silicate mixture and the mixture agitated to produce a clear solution. In a separate vessel, 1 g of 2.4 wt % TMAH was added to 24 g 0.1 M HNO₃ and mixed thoroughly. The resulting HNO₃/TMAH solution was added to the silicate solution and mixed until a clear solution was obtained. The solution was aged for several hours (a minimum 1 hour).

Approximately 1.2 ml of the solution, so prepared, was dispensed onto a silicon low resistivity wafer spinning at 500 rpm and allowed to spread for 7 seconds before accelerating the wafer to 1800 rpm. The wafer was spun at 1800 rpm for 30-40 seconds to dry the film. To produce a porous film, the film was then baked at 90° C. and 180° C. for 1.5 minutes at each temperature, before the surfactant was removed at 400° C. for 3 minutes.

The properties of the film prepared in this manner were found to be: dielectric constant =2.42, thickness =5047 angstroms, refractive index =1.2333, and modulus =2.9 GPa (as determined by means described herein above).

### EXAMPLE 2

### Comparative Example to Illustrate Workflow Provides Films with Same/Similar Properties

A Cavro robot was used to transfer 0.5 ml of the mixed solution prepared in Example 1 to a 96-well plate. The robot was also used to aspirate a 0.004 ml sample from the 96-well plate and dispense it on a low resistivity silicon wafer that was situated on a vertical shaker. Several samples (25) were then dispensed onto the wafer surface in a generally square pattern (e.g. a matrix of five rows with each row containing five samples), with the spacing between adjacent samples being about 17.5 mm. Dispensing of the liquid samples on the wafer occurred over a period of about 12 minutes, and the substrate was moved on its oscillatory path for a total duration of about 15 minutes (e.g. about 3 minutes longer than the time at which the last liquid sample is deposited on the substrate), after which movement of the substrate was stopped. Linear reciprocating movement of the wafer caused the liquid samples to spread over the wafer surface to form films thereon. The silicon wafer was then baked as described in Example 1.

The films were optically screened, yielding an average refractive index of 1.232 and a thickness of 10,100 angstroms. The dielectric constant was then measured, yielding an average value of 2.43. The Young's modulus measurements on the films had an average value of 3.1 GPa.

In this regard it is of interest to note that the films are generally thicker than those prepared using conventional spin-coating techniques, but the properties of interest (e.g., the dielectric constant and modulus) were equivalent to those prepared conventionally.

### EXAMPLE 3

### Comparative Example to Illustrate Entire Process on Small Scale Using Liquid Handling Device

A Cavro robot was used to aspirate the components and dispense them into a 96-well plate. The components were dispensed with the following order of addition: TEOS, MTES, Triton X-1 14:PGPE solution (mixed 1:4 v/v), PGPE, water, 0.1M HNO3, and 0.262N TMAH. It is to be noted that the Triton X-114 was delivered as a solution with PGPE, in order to help accurately dispense the otherwise viscous surfactant X-114. The ratio of the different components was identical to that of Example 1, but the total solution volume is only about 0.5 ml, as opposed to the 400 ml prepared in Example 1.

The 96-well plate was then capped and shaken to allow appropriate mixing of the components. The plate is then aged overnight (8 hrs). The robot was then used to aspirate a 0.004 ml sample from the 96-well plate and dispense it on a low resistivity silicon wafer that was situated on a vertical shaker. Several samples (25) were dispensed onto the wafer surface (about 125 mm in diameter) in a generally square pattern (e.g., a matrix of five rows with each row containing five samples), with the spacing between adjacent samples being about 17.5 mm. Dispensing of the liquid samples on the wafer occurred over a period of about 12 minutes, and the substrate was moved on its oscillatory path for a total duration of about 15 minutes (e.g., about 3 minutes longer than the time at which the last liquid sample is deposited on the substrate), after which movement of the substrate was stopped. Linear reciprocating movement of the wafer caused the liquid samples to spread over the wafer surface to form films thereon. The silicon wafer was then baked as in Example 1.

The resulting films were optically screened, yielding an average refractive index of 1.228 and a thickness of 10,400 angstroms. The dielectric constant was then measured, yielding an average value of 2.47. Finally, the Young's modulus measurements on the films had an average value of 3.0 GPa.

It is to be noted that construction and operation of the apparatuses described above for film formation (i.e., the apparatus for applying noncontact spreading forces, or alternatively an air knife, for forming a film on a substrate) are known in the art and will not be further described herein. Moreover, it is contemplated that other conventional screening devices may be used to screen the films formed on the substrate 23, 223, including devices capable of screening for properties other than those described previously, without departing from the scope of this invention.

When introducing elements of such apparatus, or specific embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several features of the invention are achieved. As various changes could be made in the above compositions, processes and apparatuses without departing from the scope of the invention, it is intended that all matter contained in the above description be interpreted as illustrative and not in a limiting sense.

What is claimed is:

1. A system for the research and development of films comprising:
an apparatus for receiving and combining starting components to form separate mixtures at known locations in a matrix of wells of a common receptacle;
an apparatus that receives the starting component mixtures and subjects said mixtures to conditions sufficient for a reaction to occur, thereby forming a parent library of reaction compounds;
an apparatus that receives said parent library and deposits, in liquid form, samples from one or more members of said library on a surface of at least one substrate, and subjects said samples to a spreading force sufficient to spread the samples over the surface of the at least one substrate to form respective films thereon, said apparatus comprising at least one of the following combinations of devices:
(i) a deposition device adapted for depositing at least two liquid samples on the surface of the at least one substrate in generally spaced relationship with each other, such that the at least two liquid samples are at least partially discrete from each other, and a movement device capable of supporting the substrate(s) with the liquid sample(s) deposited thereon, said movement device being operable to subject the liquid samples to a noncontact spreading force, during overlapping durations of time, sufficient to cause the samples to spread over the at least one substrate surface to form respective films thereon, at least a portion of each film being discrete from one or more other films; or,
(ii) a deposition device adapted for depositing at least two liquid samples on the surface of the at least one substrate in generally spaced relationship with each other, such that the at least two liquid samples are at least partially discrete from each other, a support for supporting the at least one substrate with the liquid sample(s) deposited thereon, and a gas delivery device operable to direct a pressurized gas to impact said liquid samples to apply a spreading force thereto sufficient to cause the liquid samples to spread over the at least one substrate surface to form respective films thereon, at least a portion of each film being discrete from one or more other films; and,
an apparatus for measuring a property of interest of said films.

2. The system of claim 1 further comprising an apparatus that receives a sample of one or more of the compounds from the parent library and forms a daughter library of compounds therefrom.

3. The system of claim 2 wherein the apparatus which receives the library and subjects a sample of one or more members to a spreading force is adapted to receive said daughter library.

4. The system of claim 1 further comprising an apparatus which filters the starting component mixtures.

5. The system of claim 1 further comprising an apparatus for transporting starting components, libraries, receptacles or substrates from one apparatus to another.

6. The system of claim 1 further comprising a control system for controlling or monitoring each apparatus.

7. The system of claim 6 wherein said control system collects data from said measuring apparatus and stores said data in a database.

8. The system of claim 6 wherein said control system synchronizes the movement of said receptacle in which said library is contained, or substrate on which said film is formed, from one station to another.

9. The system of claim 1 wherein said film-forming apparatus is operable to heat said sample to aid in film formation.

10. The system of claim 1 wherein at least about 5 films are formed on the surface of a single substrate.

11. The system of claim 10 wherein said measuring apparatus is operable to measure each film using multiple techniques.

12. The system of claim 11 wherein said measuring apparatus is operable to measure each film to determine thickness, capacitance and dielectric constant.

13. The system of claim 1 further comprising a dissolving apparatus at a dissolution station immediately before said film-forming apparatus, said dissolving apparatus being operable to dissolve members of the library and thus form said liquid samples for deposition on said at least one substrate.

14. The system of claim 1 wherein the movement device of (i) is operable to subject the liquid samples to a noncontact spreading form by moving the substrate(s).

15. The system of claim 14 wherein the movement device of (i) is operable to effect unidirectional rotational movement of the substrate(s) about an axis extending generally perpendicular to the surface of the substrate(s).

16. The system of claim 14 wherein the movement device of (i) is operable to effect orbital movement of the substrate(s) along an orbital path.

17. The system of claim 14 wherein the movement device of (i) is operable to effect reciprocating movement of the substrate(s).

18. The system of claim 14 wherein the movement device of (i) is operable to effect reciprocating movement of the substrate(s) about an axis extending generally perpendicular to the surface of the substrate(s).

19. The system of claim 14 wherein the movement device of (i) is operable to effect different types of movement of the substrate(s).

20. The system of claim 1 wherein the gas delivery device of (ii) is operable to direct pressurized gas toward the surface of the substrate(s) at an angle of incidence in the range of about 10° to about 80° to impact the liquid samples.

21. The system of claim 1 wherein said surface of each substrate has a surface area of no greater than about 1 in.².

22. The system of claim 1 wherein said at least two liquid samples are deposited on at least about 5 different substrates.

23. The system of claim 1 wherein said at least two liquid samples are deposited on at least about 50 different substrates.

24. The system of claim 22 or 23 wherein the liquid samples deposited on one of the substrates comprises a composition different from the liquid sample deposited on at least one other of said substrates.

25. The system of claim 1 wherein at least about 5 liquid samples are deposited on the same substrate.

26. The system of claim 25 wherein at least one liquid sample deposited on the substrate has a composition different from at least one other liquid sample deposited on said substrate.

27. The system of claim 1 wherein each of said deposited liquid samples has a volume in the range of about 0.5 microliters to about 100 microliters.

28. The system of claim 1 wherein each of said films has a thickness in the range of about 1,000 Å to about 10,000 Å.

29. The system of claim 1 wherein at least a portion of each of said films is substantially uniform to within a variation of about 0% to about 5%.

30. A combinatorial method for the research and development of films comprising:
forming a parent library of members in a spatially addressable format, each member comprising a mixture of starting components;
forming multiple films by (i) depositing, in liquid form, at least two samples on a surface of at least one substrate, wherein each sample is deposited on said at lest one substrate in generally spaced relationship with each other, so at to be at least partially discrete, and further wherein each sample comprises a member of the parent library, and (ii) subjecting the samples to a spreading force sufficient to spread the samples over the surface of the at least one substrate to form respective films thereon, wherein said film formation is achieved by one of the following:
(a) depositing at least two liquid samples on the at least one substrate surface in generally spaced relationship with each other, such that each of the at least two samples are at least partially discrete from each other, and subjecting said liquid samples to a noncontact spreading force sufficient to cause each sample to spread over the at least one substrate surface to form respective films thereon, at least a portion of each film being discrete from one or more other films; or,
(b) depositing at least two liquid samples on the surface of at least one substrate, such that each of the samples are at least partially discrete from each other, and directing a pressurized gas to impact said liquid samples to apply a spreading force thereto sufficient to cause the liquid samples to spread over the at least one substrate surface to form a respective film thereon; and,
measuring each film for a property of interest.

31. The method of claim 30 further comprising collecting in a database data derived from said parent library, said data comprising data sets of data elements relating to one or more of the parent library member's composition and/or formation.

32. The method of claim 31 further comprising collecting in a database data derived from said films, said data comprising data sets of data elements relating to film formation.

33. The method of claim 32 further comprising collecting in a database data derived from said films, said data comprising data sets of data elements related to film measurement.

34. The method of claim 33 further comprising correlating the collected data by comparing all or a portion of the data elements of one data set to all or a portion of the data elements of another data set.

35. The method of claim 34 further comprising reviewing said correlated data to identify films which meet a pre-determined property performance criteria.

36. The method of claim 35 further comprising using said correlated data to identify compositional and process data of said identified films for scale-up.

37. The method of claim 30 further comprising annealing the film.

38. The method of claim 30 wherein one or more of said films have a thickness in the range of about 1,000 Å to about 10,000 Å.

39. The method of claim 30 wherein at least a portion of one or more of said films is substantially uniform to within a variation of less than about 10%.

40. The method of claim 30 wherein at least a portion of one or more of said films is substantially uniform to within a variation of less than about 5%.

41. The method of claim 30 wherein the volume of the liquid samples deposited on the substrate is in the range of about 0.5 microliters to about 100 microliters.

42. The method of claim 30 wherein said films covers less than the entire surface of the substrate.

43. The method of claim 30 wherein the samples are subjected to said spreading force by directing a pressurized gas to impact said samples.

44. The method of claim 43 wherein the pressurized gas is directed toward the substrate surface at an angle of incidence in the range of about 0° to about 90°.

45. The method of claim 30 wherein the liquid samples are subjected to a noncontact spreading form by moving the substrate(s).

46. The method of claim 45 wherein the substrate(s) is(are) subjected to uni-directional rotational movement about an axis extending generally perpendicular to the surface of the substrate(s).

47. The method of claim 45 wherein the substrate(s) is(are) subjected to orbital movement along an orbital path.

48. The method of claim 45 wherein the substrate(s) is(are) subjected to reciprocating movement.

49. The method of claim 48 wherein the reciprocating movement of the substrate(s) is about an axis extending generally perpendicular to the surface of the substrate(s).

50. The method of claim 45 wherein the substrate(s) is(are) subjected to different types of movement.

51. The method of claim 30 wherein at least two liquid samples are deposited on at least about 5 different substrates.

52. The method of claim 30 wherein at least two liquid samples are deposited on at least about 50 different substrates.

53. The method of claim 51 or 52 wherein the liquid samples deposited on one of the substrates comprises a composition different from the liquid sample deposited on at least one other of said substrates.

54. The method of claim 30 wherein at least about 5 liquid samples are deposited on the same substrate.

55. The method of claim 54 wherein at least one liquid sample deposited on the substrate has a composition different from at least one other liquid sample deposited on said substrate.

56. A method for generating a database containing information relating to films, the method comprising:
combining starting components to form a series of separate mixtures at known locations in a matrix of wells of a common receptacle;
subjecting the starting component mixtures to conditions sufficient for a reaction to occur, thereby forming a parent library of reaction compounds;
forming a film of one or more library members by depositing, in liquid form, at least two liquid samples from one or more of such members on a surface of at least one substrate and subjecting the samples to a spreading force sufficient to spread the samples over the surface of the at least one substrate to form a respective film thereof;
measuring said films for multiple properties; and,
collecting data associated with each film into a database, said data comprising data sets of data elements relating to film composition, including starting component mixture content and conditions for forming the library member from which said film was derived, conditions for forming said film, and the results of measuring said film.

57. The method of claim 56 wherein said film formation is achieved by one of the following:
(a) depositing at least two liquid samples on the at least one substrate surface, such that each of the at least two samples are at least partially discrete from each other, and subjecting said liquid samples to a noncontact spreading force sufficient to cause each sample to spread over the at least one substrate surface to form-respective films thereon, at least a portion of each film being discrete from one or more other films; or,
(b) depositing at least two liquid samples on the surface of at least one substrate, such that each of the samples are at least partially discrete from each other, and directing a pressurized gas to impact said liquid samples to apply a spreading force thereto sufficient to cause the liquid samples to spread over the at least one substrate surface to form a respective film thereon.

58. The method of claim 56 further comprising forming a daughter library from said parent library by transferring a portion of one or more of said parent library compounds to known locations in a matrix of wells separate from said parent matrix of wells.

59. The method of claim 56 further comprising correlating said data in said database by comparing all or a portion of the data elements of at least one of said data sets with all or a portion of the data elements of another data set.

60. The method of claim 59 wherein multiple films are prepared and measured, and data associated therewith is collected.

61. The method of claim 60 wherein said films are measured to determine thickness, capacitance and dielectric constant.

62. The method of claim 61 wherein film composition and film thickness, capacitance and dielectric constant are correlated.

63. The method of claim 62 wherein said correlated data is screened to identify the composition of films having a dielectric constant within a pre-determined range.

64. The method of claim 59 further comprising screening said database to determine if one or more films meet screening criteria for thickness, capacitance and dielectric constant.

65. The method of claim 64 further comprising identifying a film which meets said criteria.

66. The method of claim 65, further comprising preparing a scale-up mixture of starting components which has the same composition as the first starting component mixture from which said identified film was derived, said scale-up mixture being prepared on a scale which is at least about 2 times larger than the scale of the first mixture.

67. The method of claim 66, further comprising preparing a scale-up mixture of starting components which has the same composition as the first starting component mixture from which said identified film was derived, said scale-up mixture being prepared on a scale which is at least about 5 times larger than the scale of the first mixture.

68. The method of claim 66, further comprising preparing a scale-up mixture of starting components which has the same composition as the first starting component mixture from which said identified film was derived, said scale-up mixture being prepared on a scale which is at least about 10 times larger than the scale of the first mixture.

69. The method of one of claims 66 to 68 further comprising subjecting said scale-up mixture to the same reaction conditions as said first mixture, to form a larger scale reaction product.

70. The method of claim 69 further comprising forming a scale-up film from said larger scale reaction product by depositing, in liquid form, a sample of said large scale reaction product on a scale-up substrate surface and subjecting the sample to said force under conditions the same as the conditions under which said identified film was formed.

71. The method of claim 70 further comprising measuring said scale-up film for at least one of said multiple properties for comparison to the same property measured on said identified film.

72. The method of claim 56 further comprising initially screening said database to identify one or more films meeting a first screening criteria for one or more of said multiple properties.

73. The method of claim 72 further comprising screening said database to identify one or more films meeting a second screening criteria different from said first screening criteria.

74. The method of claim 73 further comprising identifying a film which meets said second screening criteria.

75. The database of claim 56.

76. The data sets of data elements of claim 56.

77. The method of claim 56 wherein the at least two liquid samples are deposited on at least about 5 different substrates.

78. The method of claim 56 wherein the at least two liquid samples are deposited on at least about 50 different substrates.

79. The method of claim 77 or 78 wherein the liquid samples deposited on one of the substrates comprises a composition different from the liquid sample deposited on at least one other of said substrates.

80. The method of claim 56 wherein the at least two liquid samples are deposited on the same substrate.

81. The method of claim 56 wherein at least about 5 liquid samples are deposited on the same substrate.

82. The method of claim 80 or 81 wherein at least one liquid sample deposited on the substrate has a composition different from at least one other liquid sample deposited on said substrate.
